(19) United States
(12) Patent Application Publication
(10) Pub. No.: US 2004/0184450 A1
(43) Pub. Date: Sep. 23, 2004

(54) Method and system for transport and routing of packets over frame-based networks

(76) Inventor: Abdu H. Omran, Westminster, CA (US)

Correspondence Address: SEED INTELLECTUAL PROPERTY LAW GROUP PLLC, 701 FIFTH AVE, SUITE 6300, SEATTLE, WA, 98104-7092, US

(21) Appl. No.: 10/394,886

(22) Filed: Mar. 19, 2003

(51) Int. Cl. H04L 12/56

(52) U.S. Cl. 370/372; 370/475

(57) ABSTRACT

A method for transporting packets through an electronic internetwork is provided. The electronic network includes a plurality of nodes, and the transportation unit a frame. A frame is transported from a source node to one or more destination nodes. A frame comprises a payload. The payload of the frame includes one or more headers and one or more packets associated with each header. A source address is an address corresponding to the address of the source node of a packet, and a destination address is an address corresponding to the address of the destination node of a packet. A current node is a node processing a particular frame in the electronic internetwork. Each of the headers includes a destination address field that indicates the destination address of the associated packets. Headers provide mechanism for simplified routing and extracting packets.

### BACKGROUND OF THE INVENTION

The present invention relates to a telecommunication network systems. More particularly, the invention relates to a system for efficiently routing higher-layer protocols over frame-based networks, including the transport of Internet Protocol (hereinafter IP) packets over Synchronous Optical Network (hereinafter SONET) or Synchronous Digital Hierarchy (hereinafter SDH) transport.

The demand for bandwidth in data communication networks is doubling every six months. It is unlikely that this growth in demand will diminish in the immediate future. Indeed, there are reasonably reliable predictions that it may accelerate. As Voice over Internet Protocol (hereinafter VOIP), storage over IP, streaming multimedia, Internet appliances and wireless 3G networks proliferate, the demand for bandwidth will only increase.

Telecommunication service providers are faced with two significant obstacles to this explosive growth. First, existing, or legacy, telecom networks were not designed to transport packet-based data efficiently, and certainly were not designed to scale up in data-handling capacity at the rate that packet-based data traffic is increasing. Second, most existing telecoms' primary revenue streams are based on voice data, while their fastest-rising and most significant demands and costs are those associated with the increase of packet-based data traffic. Thus, the telecoms are faced with a dilemma. They can either invest significant amounts of capital to build high-capacity data networks or risk obsolescence.

Data is generally switched two ways. Voice, for example, has historically been circuit switched. In a circuit switched network, each data stream is sent over a circuit between the sender and the receiver. This circuit is dedicated for exclusive use for the duration of the data transmission. Although circuit switching is convenient for voice data such as telephone calls, it is very inefficient for other types of data communications. Digital data, such as a file being downloaded, is generally packet switched. That is, a data file is segmented into multiple packets. The individual packets are then sent along whatever path(s) is (are) available to their destination where they are reassembled into the transmitted file.

Historically, telecoms only had to transport voice traffic. Data traffic came along much later, and input/output devices were developed to interface data sources with telecoms' legacy networks. By the mid-to-late eighties, telecoms had developed the practice of maintaining distinct parallel networks for voice and data. The voice networks remained circuit switched. The data networks were packet switched. In the early nineties, the first efforts began to converge circuit switching to the packet switching model.

In the early nineties, telecommunication engineers began developing mechanisms for connecting the separate voice and data networks to a common SONET ring. SONET (as well as SDH, the standard widely used outside of North America) permitted multiple services based on Time Division Multiple Access (hereinafter TDMA) to be multiplexed from lower-speed, for example, voice, circuits into layers in the SONET hierarchy. The tremendous bandwidth available over the common SONET/SDH interface made it attractive to carry IP traffic over a frame relay and/or an Asynchronous Transfer Mode (hereinafter ATM) backbone network. As the volume of IP traffic increases, it becomes more desirable to carry IP traffic directly over SONET, at least in the network backbone where demand is high and increasing.

Currently, the focus of IP transport continues to be data-oriented. However, a significant trend in the industry is the emerging demand for the support of real-time IP services, such as IP telephony. With the increasing demand for such services, there is an attendant need to develop SONET/SDH data routers with sophisticated Quality of Services (hereinafter QoS) mechanisms.

By the mid nineties, telecommunication engineers routinely encountered the need to efficiently transport and route large amounts of packet-formatted data, namely IP data, originating from Local Area Networks (hereinafter LANs). A solution they developed was to locate ATM networks as intermediate transport layers between the LANs and backbone SONET rings. In the short term, ATM was a good solution. ATM provided extensive bandwidth management, wire speed switching, network based addressing, routing, and QoS control over the network. ATM also provided for the convergence of circuit-switched data (such as voice) and packet-switched data (such as IP-based file transfers) onto a single transport system.

However, using an ATM layer was not a perfect solution. An ATM network is a cell-based network, and the Public Switched Telephone Network (hereinafter PSTN) is Time Division Multiplexed (hereinafter TDM). Telecommunication engineers used ATM networks in the beginning to transport circuit-switched data such as T1, Digital Subscriber (at 1.544 Mb/s), and DS-3 (45 Mb/s). The overhead resulting from ATM headers and data packetization resulted in inefficiency in bandwidth utilization. Additionally there is some time delay associated with ATM because ATM is connection oriented and a connection takes a finite time to set up. Further, to transport circuit-switched data over an ATM network requires equipment called a Circuit Emulation Switch (hereinafter CES) to convert the TDM traffic to ATM cells for transport. Then, as the traffic arrives at its destination it must be converted back to TDM. This added functionality and control is expensive both in terms of the overhead bandwidth and the capital cost of adding another network layer.

By the late nineties, IP had evolved to the point where it incorporated much of the network management functionality of ATM. Now it was possible to transport IP packets over SONET without requiring an intermediate ATM layer. However, the Packet Over SONET (hereinafter POS) protocol that was developed for this purpose requires the IP data to undergo an encapsulation process. This multi-level encapsulation process starts by encapsulating the IP packet in a Point-to-Point Protocol (hereinafter PPP) frame. This PPP frame is then framed using a High-Level Data Link Control (hereinafter HDLC)-like framing for packet delineation and error control. These frames are then transported inside of SONET frames. Although these HDLC frames are sent inside of SONET frames, the POS frames are sent as a byte-oriented stream using a point-to-point link to the next node. They do not make use of the framing information that is provided by the SONET overhead bytes. And, because PPP is used, the packet must pass through every node in the network and be regenerated at each node for transit to the next node. This process includes a costly segmentation and reassembly of the packet. In some cases the POS protocol was then transported over ATM, resulting in further inefficiencies resulting in 40 to 45% of the system bandwidth being used for overhead.

With existing POS systems, PPP is used with the SONET ring because SONET was originally designed as a point-to-point network. In these systems, the packet must pass through every node in the network and be regenerated at each node for transit to the next node. Also, PPP alone is not sufficient for true data encapsulation. It can be used for mapping and translation only if the X.25 HDLC protocol and a mechanism called Address Resolution Protocol (hereinafter ARP) are employed to translate and map each data packet to its destination through the point-to-point SONET network. However, this requires stripping out the HDLC frame at each node, analyzing the header and then re-packaging it for the next PPP link.

SONET was originally designed to be a simple transport system for TDM voice signals that could be used at high line rates using, by modern standards, relatively simple electronics. Because of this, SONET protocols are less well suited as data transport protocols than protocols specifically designed for data transmission, such as IP or ATM. SONET engineers have focused on increasing line rates and improving administration tools rather than improving the intrinsic data transport performance of SONET. To date, data transport over SONET has been accomplished by adding protocol layers above the SONET transport layer.

With many of the existing routing and data transfer protocols approaching their speed and bandwidth limits, some network engineers have turned their attention to increasing the raw bandwidth of SONET rings. Many solutions have developed around large channel-count Dense Wavelength Division Multiplexing (hereinafter DWDM) and running the rings at very high speeds, up to Optical Carrier (hereinafter OC)-768. These “brute force” solutions of simply making available the capacity to transmit photons at a greater number of discrete frequencies around the ring are capital intensive and complex. Every time a wavelength is split, for example, at a node in a DWDM network, the signal strength is divided. Thus, the optoelectronics must be able to process increasingly fainter signals. When the whole system is run at very high speeds, the problems are compounded. Indeed, many speculate that OC-768 optoelectronics can only be made from esoteric compound semiconductors such as InP.

The present invention proposes an alternative to this brute force approach, namely to identify and remedy inefficiencies, thereby improving the utilization of the existing SONET infrastructure.

Another important aspect of modern data communications is the increasing importance of reliability and latency. Telephone services require a very high level of availability and low latency. The normal standard of operation is the so-called “five nines” standard of reliability. That is, the system must be available 99.999% of the time. This corresponds to an acceptable outage of five minutes per year. Although this provides an excellent level of service, the emerging standard is “six nines.” That is, the system must be available 99.9999% of the time. Many existing IP network technologies (such as Ethernet LANs) do not have high levels of reliability and predictable latency because they were not developed for voice transport. At the same time, as the Internet evolves and an increasing amount of loss-sensitive and time-critical information is transported using IP packets, there is a corresponding increase in demand for reliable transport of IP traffic. This is one of the reasons why SONET remains an attractive technology for the transport of IP traffic.

One of the reasons for SONET's reliability is that, in most installations, data circulates in opposite directions around dual optical fiber rings to provide redundant connectivity between the nodes.

FIG. 1 illustrates a typical SONET Bidirectional Line Switched Ring (hereinafter BLSR) in which data frames 105 and 106 flow in opposite directions in an inner ring 107 and an outer ring 108. Under normal operation, each ring carries traffic that is one-half or less of its total capacity. In the event of the failure of a segment of one of the rings, each node that is adjacent to the failure will wrap traffic between the inner and outer rings. This permits the network to continue to operate in the event of disruption of the working ring or network equipment such as Add/Drop Multiplexers (hereinafter ADM) 101-104 at any location along the working ring. SONET systems have Automatic Protection Switching (hereinafter APS) to detect signal failures and switch traffic between the inner and outer rings to isolate and direct traffic around the fault. If the SONET system is being used to transport IP traffic, the ADMs typically will be connected to IP routers 109, 111, and 113.

As noted above, SONET uses TDM to multiplex and demultiplex low-speed data traffic to or from a high-speed optical transport network. Each such low-speed connection is semi-permanently allocated a fraction of the capacity of the high-speed ring by “provisioning” bandwidth. This provisioning assigns bandwidth from each node to each other node. This provisioning can be thought of as a multi-lane highway in which a lane is allocated for traffic from one ADM to another ADM. Since SONET is a TDM system, the lanes are provisioned by allocating time slots in the TDM sequence. With provisioning, the communication between each pair of ADMs is point-to-point. That is, if a specific set of time slots are provisioned for sending traffic 106 from ADM 104 to ADM 101 along the outer ring 108, that provisioned capacity is not used for any other purpose by the equipment on the ring. ADMs not using a particular lane simply forward traffic not addressed to them, without inspecting or otherwise processing it.

SONET was designed to be a reliable circuit-switched network. SONET owes its reliability in part to the 100% capacity redundancy. As noted above, SONET provides two fiber-optic rings. Each ring normally carries 50% or less of its rated capacity. However, when SONET is being used to transport bursty, packet-based traffic such as IP, the 100% redundancy requirement results in considerable excess capacity. For IP traffic, it is more effective to require 100% redundancy only for traffic that requires relatively high availability under the terms of a service-level agreement (hereinafter SLA) between the carrier and the customer. Traffic that does not require such availability can be transported using capacity that is not supported by redundancy. In the event of a ring failure, low priority traffic is reduced so that traffic requiring high availability can be transported in accordance with the terms of outstanding SLAs.

One method for the transport of IP traffic that can be used with SONET is Dynamic Packet Transport (hereinafter DPT), which uses Spatial Reuse Protocol (hereinafter SRP). SRP does not use point-to-point links in the traditional sense. With SRP, IP packets are transported inside of SRP packets and the SRP data is sent as a byte-oriented stream that does not utilize the SONET framing mechanisms. Referring to FIG. 2, an IP packet 201 is encapsulated and has its own SRP header 205. The SRP headers contain information that is used as an addressable link-layer protocol.

At each SRP node, the destination address for every SRP packet is inspected to determine if the destination is the current node. If it is, the SRP packet is stripped from the data stream and processed by the current node. If the destination is not the current node, the current node performs a table lookup to determine which optical interface is the destination for that SRP packet. Because SRP utilizes both rings concurrently, it supports two sets of optical interfaces per node.

SRP requires a plurality of packet buffers for its operation. Essentially, traffic from the current node is sent to an output optical interface whenever there is available capacity in the optical transport system. The detailed decisions regarding which packets are sent to the output depend on the priority and the source of the traffic. Packets remain buffered until they are sent. A global fairness algorithm provides each node fair access to the capacity of the ring. SRP does not observe the SONET paradigm of having 100% capacity redundancy between the inner and outer rings. Instead, all of the capacity in both rings is available for transport. SRP has its own protection mechanism. It does not use SONET's protection switching. If a protection switching event, such as a break in one of the rings, occurs, the network capacity in the vicinity of the event is reduced. This, of course, affects the total capacity of the optical network.

### SUMMARY OF THE INVENTION

This invention relates to methods and apparatus by which a routeable protocol, such as IP, can be efficiently transported and routed using a frame-based transport network, such as SONET and or SDH. The methods and apparatus include a protocol, Frame Encapsulation Protocol (hereinafter FEP), for efficiently aggregating and transporting routeable packets that are located within the payload portion of frames. The methods and apparatus are disclosed in the context of the SONET protocol, but are believed to be useful in other applications as well.

Methods and apparatus are provided by which routeable packets can be efficiently transported and routed within a frame-based network. Packets having a common next hop or destination are mapped into source-routed frames. The methods and apparatus also support multicast and have features to support traffic engineering for guaranteeing QoS.

Because they are SONET-compliant, the methods and apparatus can be used transparently on existing SONET networks. The FEP is not directly compatible with existing packet transport methods. However, an FEP-capable node can emulate less efficient legacy methods to operate with equipment using existing IP transport mechanisms such as POS or IP over ATM (IPOATM). The methods and apparatus provide efficient packet transport using LAN Emulation.

The methods and apparatus are unlike prior art methods and apparatus for transporting IP packets over SONET in that they do not use PPP, HDLC, or ATM. However, they do use the SONET framing mechanism. And, although nodes incorporating the present methods and apparatus can operate via conventional point-to-point connections, the present methods and apparatus permit multiple nodes to share the capacity of one or more provisioned (or un-provisioned) optical links.

The present methods and apparatus comply with SONET standards. At the transport level, the present methods and apparatus are compatible with existing SONET-compliant network equipment. Thus, rather than requiring the expensive upgrading or replacement of existing equipment, the present methods and apparatus can operate transparently on rings containing legacy equipment. This is unlike other proposed improvements to SONET, such as Cisco Systems' DPT, or “SONET-lite,” as it is sometimes called, that use a SONET-like transport system, but break compatibility with existing SONET equipment.

The present invention, FEP is also different from the Spatial Reuse Protocol (SRP) that is used in DPT. While SRP has its own protection switching, which is not compatible with SONET Switching mechanism, FEP is completely compatible with SONET, and SONET switching mechanism is utilized. While SRP does not have any method for data encapsulating over SONET, and use old PPP, with HDLC packet, FEP uses its new encapsulating mechanism for transport IP Packet. The destination address and source address are 32-bit IP address in FEP, while they are 48-bit MAC address in SRP. While MAC addresses are used by direct lookup, IP addresses have a hierarchical structure, which are used in different depths by different IP subnets. IP packets are included in an SRP packet as the payload. In FEP, an FEP header is separate from IP packet(s) associated with the header. Thus, only the initial part containing the FEP headers in the payload of a SONET frame need to be read, and header concatenation without repeating the IP packet for the concatenation is possible.

In an embodiment FEP packet has a fixed size, and smaller than the IP packet which is 1500 Byte. FEP packet has same overhead as IP packet, and carry the same payload data as IP packet.

An object of the invention is to provide a method and a system for efficient transport of user traffic over a frame-based internetwork.

Another object of the invention is to provide a method and a system for maximizing the use of transport capacity of a frame-based network for IP traffic.

Still another object of the invention is to provide a method and a system for effectively routing packets having different destinations conveyed in one frame with minimal overhead.

In order to achieve the objects, the present invention provides a method for transporting packets through an electronic internetwork. The electronic network includes a plurality of nodes, and the transportation unit of the electronic internetwork is a frame. The method includes a step of transported a frame from a source node to one or more destination nodes. A frame comprises a payload, and the payload of the frame includes one or more headers and one or more packets associated with each header. A source address is an address corresponding to the address of the source node of a packet, and a destination address is an address corresponding to the address of the destination node of a packet. A current node is a node processing a particular frame in the electronic internetwork. Each of the headers includes a destination address field that indicates the destination address of the associated packets. The packets are IP packets, and the frame is a SONET frame. The the header is used as a MAC layer header.

Each of the nodes is connected to a local network, and the method further includes a step of forming a frame with a packet or packets from the local network at the source node.

The transporting step includes header reading step and frame processing step. The header reading step includes destination address reading step, in which the value of the destination address field of a header is read. In the frame processing step, if the value read in the destination address reading step matches the address of the current node, the packets associated with the header are extracted, and the header reading step and the frame processing step are repeated for each header.

In the frame forming step, when there are packets from the local network connected to the current node, the current node constructs headers for packets from the local network connected to the current node and fills the payload of a frame with the headers and packets. If the frame received from the previous node is discarded, the current node forwards the frame to the next node. If there is no frame to forward, the current node forwards an advertising frame to the next node.

The header further includes a source address field that indicates the source address of the associated packets. The size of the destination address field is 32 bit, and the size of the source address field is 32 bit. A frame is marked advertising by setting the destination address field and the source address field of header to zero.

When the remaining capacity of the payload of a frame has less than a predetermined remaining capacity parameter, the payload is queued for transport. Packets from the local network are stored in a buffer, and the payload is queued for transport when the time elapsed since the first packet was copied into the buffer is equal or greater than a predetermined latency requirement.

The header further includes a delivery requirement field that indicates a packet transport level of the associated packet. The delivery requirement field indicates priority of queuing of the packet. Packets are filled in the payload of the frame according to the value of the delivery requirement field of the header associated with the packets.

The payload of a frame is filled with packets having the same packet transport level. If the capacity remaining in the payload is less than a predetermined packing limit and there is no packet having the same packet transport level, packets having increasingly disparate packet transport level are filled.

The header further includes a destination strip filed that instructs the destination node whether or not to forward the frame. When the packet is a broadcast packet, the destination address field is set to all ones, and the destination strip field indicates that the packet and the header should be forwarded to the next node.

The header further includes a next header field, which indicates whether another head follows immediately the header or a packet follows immediately the header, and an offset pointer field, which indicates the start position of the packets associated with the header measured from the start of the payload of the frame.

In the frame processing step, if the value read in the destination address reading step matches the address of the current node, the next header field is checked. If the next header field indicates that a packet follows the header, the offset pointer field is used to locate the starting position of the packets associated with the header. If the next header field indicates that another header follows the header, the offset pointer field is used to locate the starting position of the packets associated with the header, and the offset pointer field of the another header is used to locate the end position of the packets associated with the header.

More than one header may be associated with one packet. In this case, the offset point field of the headers have the same value. Each of the headers has a different value for the destination address field. The headers are placed at the start of the payload of a frame, and the packets are placed after the headers. The packets are grouped in the same order as the headers.

If the capacity remaining in the payload is less than a predetermined packing limit and a packet that is sought to fill the payload is larger than the predetermined packing limit, the packet is used to begin filling the payload of a subsequent frame, wherein if the capacity remaining in the payload is greater than the predetermined packing limit and a packet that is sought to fill the payload is larger than the remaining capacity, the packet is fragmented.

The header further includes a fragment length field that indicates the length of the first packet associated to the header if the first packet is a fragmented packet. When the packet is fragmented, the fragment length field of the header of the next frame associated with the fragmented packet is set to the number of octets of the fragmented packet.

The header further includes a hop limit field that indicates hop limit. The initial value of the hop limit field is controlled by a hop limit parameter that is adjustable by software at the node that the header is created. Each node that forwards a frame decrements the hop limit field by one. The frame is discarded if the value of the hop limit is zero.

The header further includes a read filed that indicates whether the destination node has read the header. The read field is initially set to zero, and the read field is set to one if the destination address read in the destination address reading step matches the address of the current node. If the read field of every header in a frame indicates that the header is read, the frame is dropped.

In case that the electronic internetwork has a ring topology, the header further includes a ring indicator field that indicates the ring on which the frame was originally sent.

The header further includes a sequence number field that indicates a sequence number of the header. The sequence number field is a modulo-64 counter.

The header further includes a header error control field that is used for cyclic redundancy check.

The frame may include two or more subframes. Each of the subframes includes one or more headers and one or more packets associated with each header.

The packet may have a predetermined size. In one embodiment, the predetermined size is 43 bytes. The header also may have the predetermined size.

The header and the packet may be combined as a unit, and the unit may have a predetermined size.

The invention also provides a system for transporting packets through an electronic internetwork, The electronic network includes a plurality of nodes, and the transportation unit of the electronic internetwork is a frame. A frame is transported from a source node to one or more destination nodes. A frame comprises a payload, and the payload of the frame includes one or more headers and one or more packets associated with each header. A source address is an address corresponding to the address of the source node of a packet, and a destination address is an address corresponding to the address of the destination node of a packet. A current node is a node processing a particular frame in the electronic internetwork. Each of the headers includes a destination address field that indicates the destination address of the associated packets.

Each of the nodes is connected to a local network, and a frame is formed with a packet or packets from the local network at the source node.

The current node reads the value of the destination address field of each of the headers. Tf the value read matches the address of the current node, the current node extracts the packets associated with each of the headers.

### BRIEF DESCRIPTION OF THE DRAWINGS

These and other features, aspects and advantages of the present invention will become better understood with reference to the accompanying drawings, wherein:

FIG. 1 is a schematic diagram illustrating a SONET BLSR network by prior art;

FIG. 2 is a schematic diagram illustrating the transport of IP packets using SRP and SONET by prior art;

FIG. 3 is a schematic diagram illustrating the contents of a SONET Synchronous Transport Signal level 1 (hereinafter STS-1) frame;

FIG. 4 is a schematic diagram illustrating the flow of traffic in a four-node SONET BLSR network;

FIGS. 5a, 5b, 5c, 5d, 5e, 5f and 5g are schematic diagrams illustrating the contents of a payload of a SONET frame;

FIG. 6 is a schematic diagram illustrating the format of an FEP header;

FIGS. 7a and 7b are schematic diagrams, which illustrate data handling by an FEP-capable node;

FIG. 8 is a diagram showing a payload of a frame using header concatenation with multiple FEP headers and packets destined for multiple nodes;

FIG. 9 is a schematic diagram showing the devices performing the FEP;

FIGS. 10a and 10b are flow diagrams showing a process for constructing a frame that supports payload aggregation and header concatenation;

FIGS. 11 and 12 are flow diagrams showing a method for transporting packets through the electronic internetwork in case that the frame includes single FEP header;

FIG. 13 is a flow diagram showing a process for constructing a frame with packets from a local network;

FIG. 14 is a flow diagram showing a process for sending frames at the current node;

FIG. 15 is a flow diagram showing a process for identifying the start and end positions of the packets to be extracted;

FIG. 16 is a flow diagram showing a process for fragmenting a large packet;

FIG. 17 is a flow diagram showing a process for header concatenation; and

FIG. 18 is a flow diagram showing a process for using a flag for checking that packets associated for a particular head are already read.

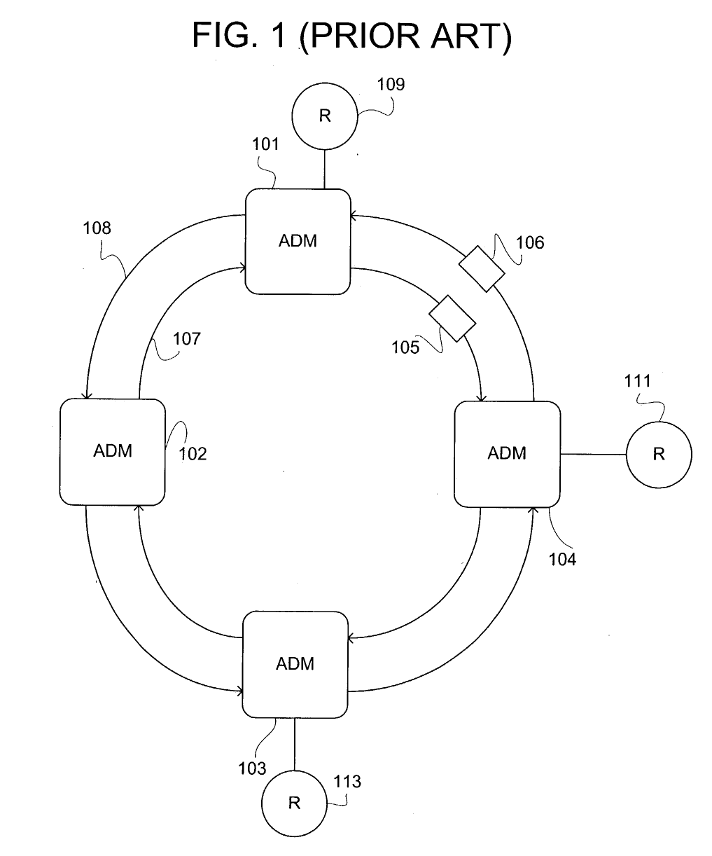

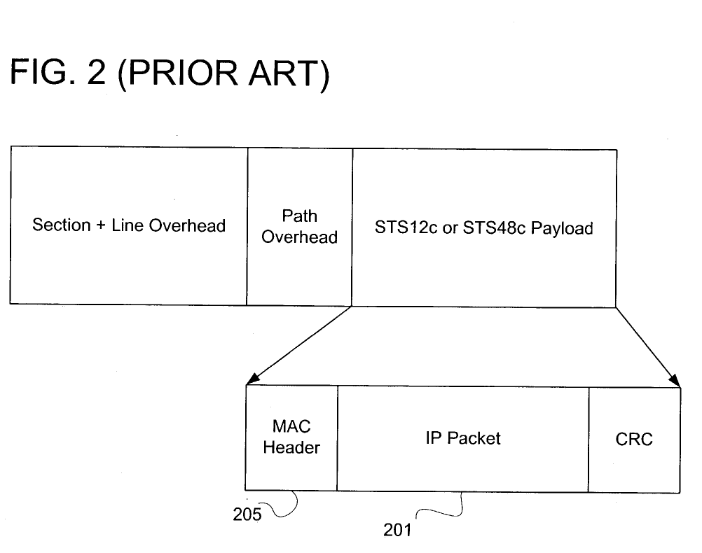

### DETAILED DESCRIPTION OF THE PREFERRED EMBODIMENTS

The term frame, as used herein, means a fixed-length logical unit of data that is typically arranged as a binary sequence having a specified number of octets of data. The term packet, as used herein, refers to a fixed- or variable-length sequence of data having a header containing control information such as a destination address. The term destination, as used herein, generally means either a final destination or the terminal end of a next hop.

In an embodiment of the present invention, the FEP is used for transporting IP packets with a SONET network. SONET has been adapted for the transport of other forms of data traffic such as ATM cells and IP packets. A primary reference document for SONET is Bellcore GR-253 “Synchronous Optical Network Transport System,” which is incorporated herein by reference. SONET multiplexing equipment, such as ADMs, send frames of data to each other over provisioned TDM channels. SONET was originally designed for the transport of digitized telephone conversations at a frame rate of 8 kHz. Since the frame rate is fixed, higher data rates are accommodated by sending larger frames. In the SONET standards, the resulting data rates are integral multiples of 51.84 Mbps, which is referred to as STS-1. These data rates include:

| | | |
|---|---|---|
| STS-1 | | 51.84 |
| STS-3 | OC-3 | 155.52 |
| STS-12 | OC-12 | 622.08 |
| STS-48 | OC-48 | 2,488.32 |
| STS-192 | OC-192 | 9,953.28 |

in which the OC designations are used in the context of data transport over optical links. An OC-12 ring can transport twelve STS-1 tributaries.

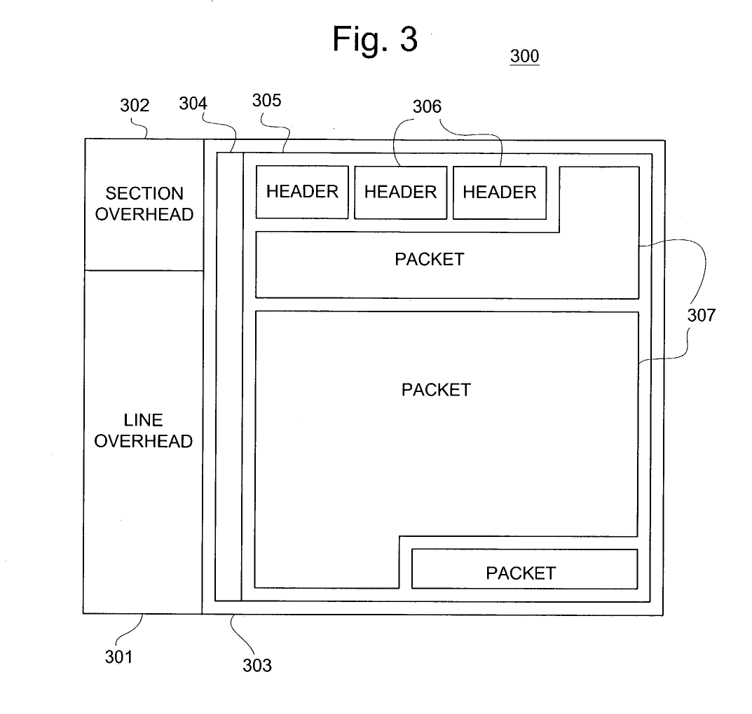

FIG. 3 shows an STS-1 SONET frame 300 into which headers 306 for FEP and packets 307 corresponding to the headers 306 are included as the payload. The SONET frame 300 includes bytes for line overhead 301, bytes for section overhead 302, and bytes within the synchronous payload envelope (SPE) 303. The SPE 303 contains bytes for path overhead 304, bytes for payload 305. As illustrated above, multiple STS-1 tributaries can be transported over a higher-speed link. For example, an STS-3 frame contains three STS-1 tributaries, which are byte-interleaved inside of the STS-3 frame. Each SONET frame is arranged as nine rows. The frame data is transmitted over a serial optical link starting with the first byte in the first row, and proceeding row-wise until the entire frame has been transmitted.

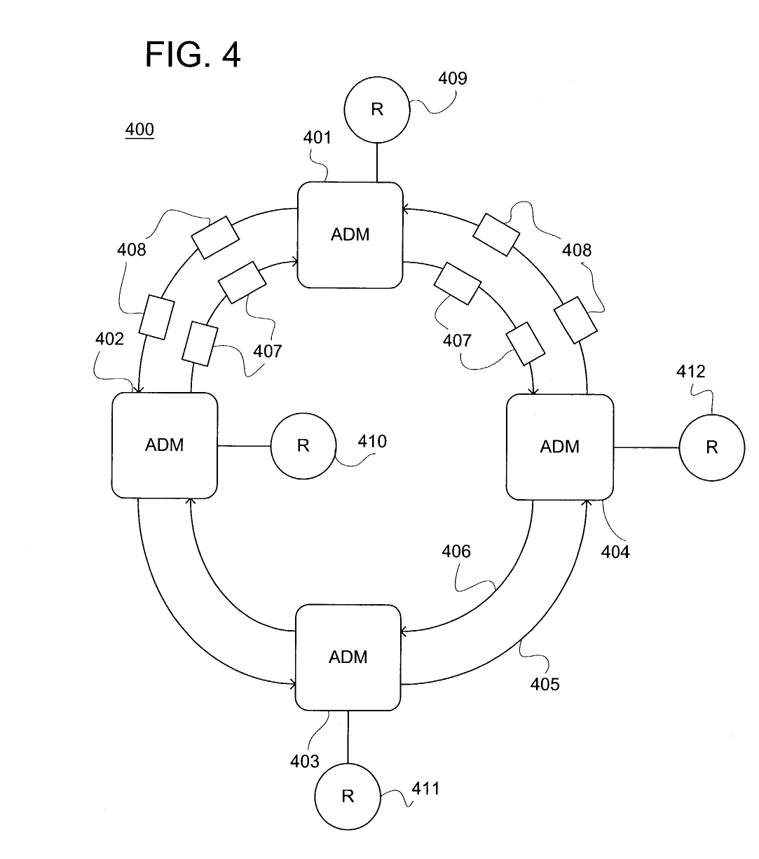

In a SONET system 400 illustrated in FIG. 4, a number of nodes 401-404 (illustrated as ADMs) are interconnected using two rings 405, 406 of optical fiber. Data frames 408 in one ring 405 are transported in a first direction, counter-clockwise in FIG. 4. Data frames 407 in the other ring 406 are transported in a second and opposite direction, clockwise in FIG. 4.

The SONET system 400 is used for transporting IP packets. The ADMs 401-404 are connected with routers 409-412. The routers 409-412 forward the IP packets to other connected networks, such as Ethernet or ATM networks.

The transport capacity between ADMs 401-404 is provisioned by programming each ADM 401-404 to send or receive its data using specified STS-1 tributaries within the SPE 303. Any STS-1 tributary that is not used by that node 401-404 for sending or receiving data is forwarded unmodified to the next node 401-404 along the ring. In the OC-12 ring, for example, if two STS-1 tributaries are provisioned for sending data from node 404 to node 402, then node 401 will forward those STS-1 tributaries without inspecting or modifying them.

As an example of SONET operation, consider sending data over the OC-12 ring between nodes 404 and 402 using the first and second STS-1 tributaries. Frames 408 of data depart from the node 404 on the fiber-optic ring 405 and arrive at the node 401. The node 401 forwards these two tributaries unmodified (although it may act upon other STS-1 tributaries).

FEP can operate on networks that use provisioning, as well as on networks that do not use provisioning. The support for provisioning permits nodes 401-404 having reduced complexity, since tributaries that are simply forwarded require less processing than tributaries that the node 401-404 must process. Also, FEP can concurrently use both rings 405, 406. Additionally, FEP can be extended to more than two rings.

Unlike existing encapsulation methods such as PPP, FEP does not require a point-to-point link. Instead, FEP uses an addressable multiple-access frame-based routing that permits the entire frame 408 to be routed over a frame-based transport layer having multiple nodes 401-404 sharing the same communication channel. The addressable multiple-access frame-based routing is explained below.

IP packets are routed and mapped into SONET frames 408. The SONET transport network 400 may include multiple nodes that are interconnected within rings or meshes. The rings and meshes can also be interconnected to form a wide-area network (hereinafter WAN) for packet transport. The network topology can include multiple paths between destinations for greater availability. Routing over these multiple paths can use existing routing protocols.

IP packets are aggregated into the frames 408. The size of a frame 408 is implementation-dependent. In an embodiment, the payload size of a frame is 774 octets, which is the size of a SONET STS-1 frame, less the line, section, and path overhead. IP packets have variable lengths of up to 65536 octets, although Ethernet networks use a Maximum Transfer Unit (MTU) of 1522 octets. The typical packets in an IP network are relatively small, on the order of 43 octets.

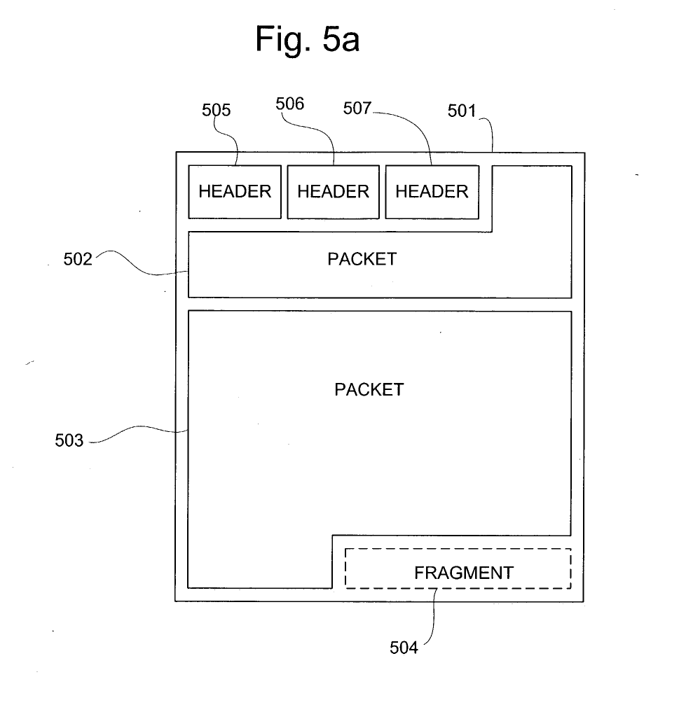

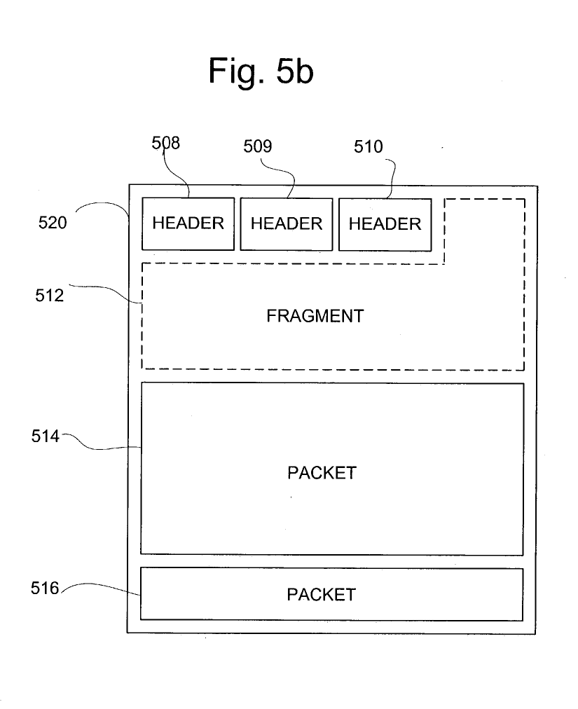

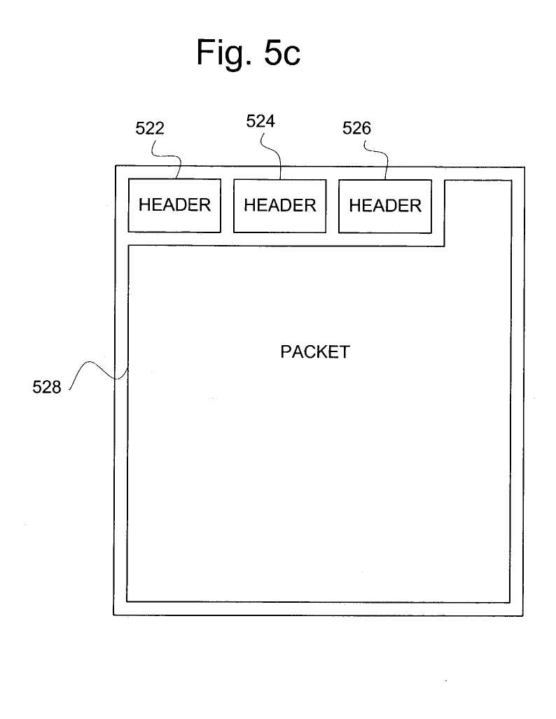

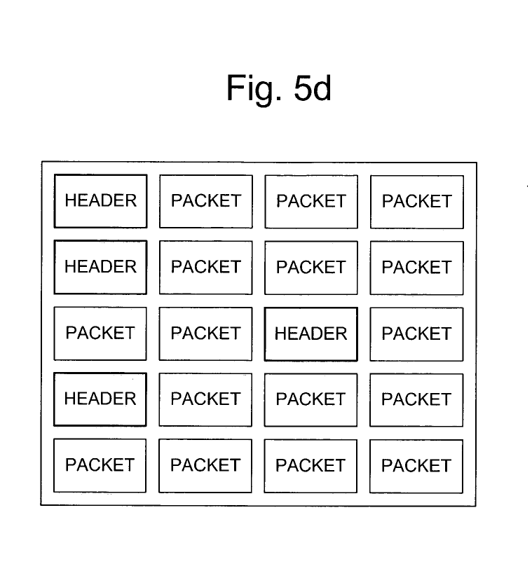

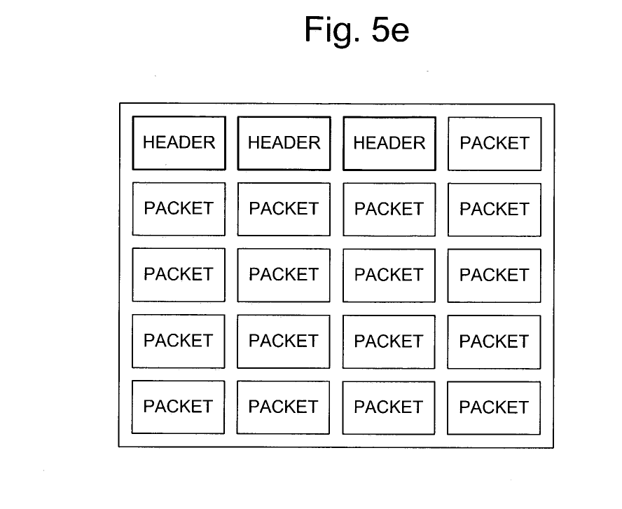

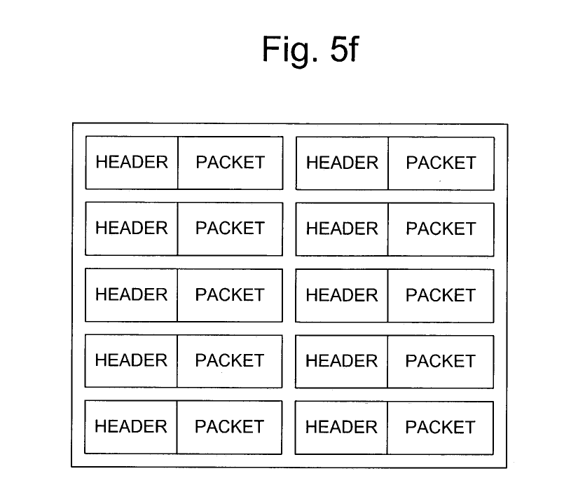

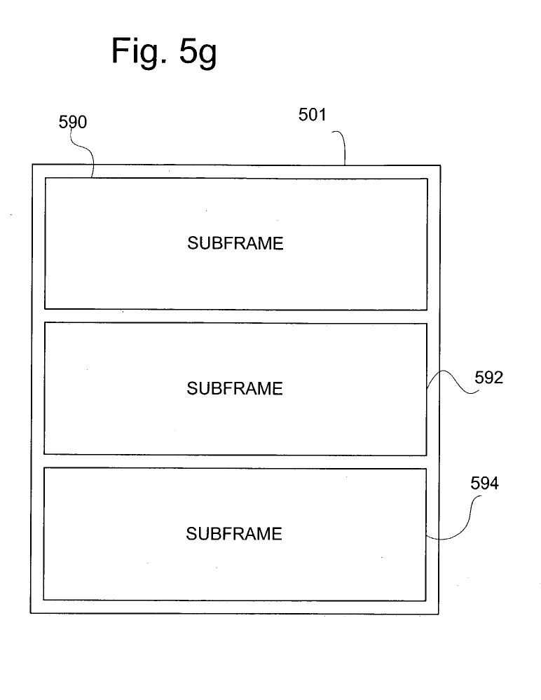

As shown in FIG. 5a, several IP packets 502-504 can be transported in a payload 501 of a SONET frame. FIG. 5a also shows FEP headers 505-507 that correspond packets 502-504.

Alternatively, a frame such as a SONET STS-1 frame can be divided into subframes as shown in FIG. 5g. For example, the 774 octet payload 501 can be divided into three 258 octet subframes 590, 592, 594. Each of these subframes can be treated as a separate FEP frame having a smaller capacity than the original frame 408. This can be used, for example, to control the granularity of the data transport system. That is, it further facilitates the transport of data packets addressed to multiple addresses in a common frame so that, for example, each of three consecutive subframes can contain 258 octets of data bound for one of three different addresses, rather than having a frame containing 774 octets of data bound for a first one of the three addresses, a later frame containing 774 octets of data bound for a second one of the addresses, and a still later frame containing 774 octets of data bound for a third one of the addresses. There is some increase in transport overhead because of the multiple headers in the frame, but the use of subframes permits the network to be tuned to the traffic and latency demands of subscribers, or otherwise for optimum performance.

Each of the FEP headers 505-507 is used for a Medium-Access Control (hereinafter MAC) layer protocol. The FEP header includes 18 octets of information.

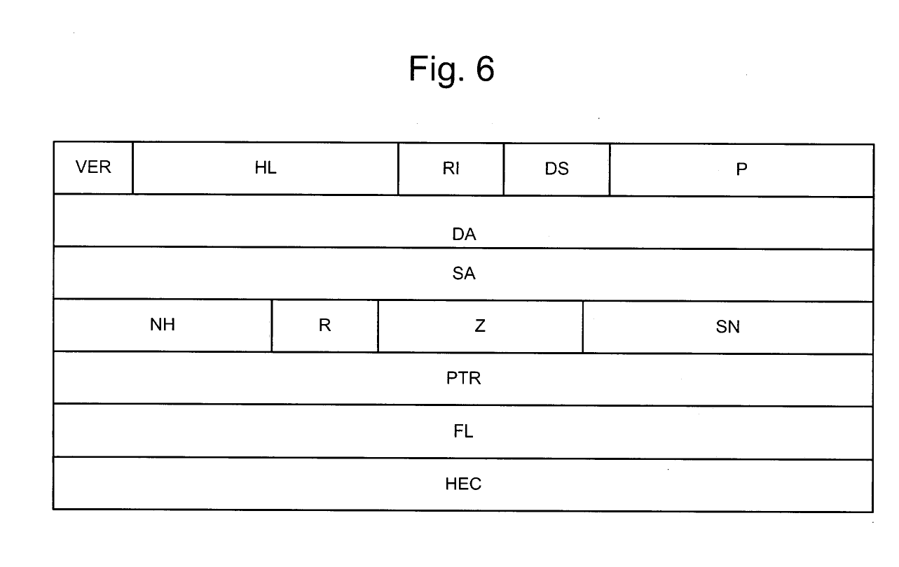

FIG. 6 shows the format of the FEP header. The first field in the header structure a 2-bit version number (hereinafter VER), currently zero. VER is incremented (modulo 4) whenever a new version of the FEP header is released.

The second field is an 8-bit Hop Limit field (hereinafter HL). The node that originates the frame 407, 408 uses a software-selectable parameter to set the initial value of HL. Each node that forwards the frame 407, 408 decrements HL by one. The frame 407, 408 is discarded if HL reaches zero. The purpose of HL is to prevent frames 407, 408 from continuously circulating around the ring 405, 406 if the frame has a bad destination address, the node 401-404 is malfunctioning, or if either of the destination or source nodes exit the network. For the same reason, on ring-based networks, any frames 407, 408 that return to the originating node along the same ring along which the packet was sent are dropped.

The next field is a ring indicator bit (hereinafter RI) specifies the ring on which the packet was originally sent. It may be set to zero for the outer ring 405 and to one for the inner ring 406, for example.

The next field is a Destination Strip bit (hereinafter DS). DS instructs the destination node whether or not to forward the packet or packets associated to the header.

The next field is a 4-bit Priority (hereinafter P). P is used to indicate the delivery requirement of the packet or packets associated to the header. The delivery requirement includes the priority, latency requirements, and loss tolerance. P helps control frame transport queuing and, in the illustrated embodiment, has the same meaning as the IPv6 priority field in IP. P helps provide the QoS verification for each SLA.

The next field is a 32-bit Destination Address (hereinafter DA). DA indicates the destination of the packet or packets associated to the header, a unique address of a specific interface on a particular node.

The next field is a 32-bit Source Address (hereinafter SA). SA indicates a specific interface on the source node. The use of these address fields DA, SA is similar to that of the 48-bit MAC address in the IEEE 802 standard.

The next field is an 8-bit Next Header field (hereinafter NH). NH indicates the type of data that immediately follows the FEP header. In this embodiment, if IPv4 packets follow the FEP header, NH is set to 01 (hexadecimal) whereas if another FEP header follows the FEP header, NH is set to 04 hex. NH provides a mechanism for header concatenation. The header concatenation is explained later.

The next field is a Read bit (hereinafter R). R is initially set to zero. It is set to one by the destination node to indicate that the destination node has read the header. This is useful when determining the drop location(s) of frames containing concatenated headers.

The next field is a reserved bit (hereinafter Z). Z is unused in this embodiment.

The next field is a 6-bit sequence number field (hereinafter SN). SN is a modulo-64 counter that is used to ensure in-order processing of frames 407, 408 by the receiving node. This aids the correct reassembly of packets that are fragmented across frame boundaries.

The next field is a 16-bit offset pointer (hereinafter PTR). PTR is the index in octets of the start of the data packets for the destination node specified by DA in the current header. It is measured from the start of the payload area.

The next field is a 16-bit fragment length field (hereinafter FL). FL indicates the length of the packet fragment, if any, for the first packet for this FEP header. If there is no packet fragment, this is set to zero.

PTR and FL simplify packet extraction. PTR permits a frame processor to locate the start of the packet data for this destination node more readily. FL aids in locating the packet that immediately follows the fragment.

The next field is a header error control field (hereinafter HEC). HEC is a 16-bit cyclic redundancy check (hereinafter CRC) that is computed over all of the other header bits. In the illustrated embodiment, the CRC generator polynomial is the ITU standard x¹⁵+x¹²+x¹⁵+1.

The FEP header structure is summarized as a table below.

| Name | Size | Description |
|---|---|---|
| VER | 2 Bit | New Version of software FEP header is |
| | | released |
| HL | 8 Bit | Hop limitation, same as a TTL |
| RI | 2 Bit | Ring Indicator use in SONET Rings |
| | | transport Frame |
| DS | 2 Bit | Destination Strip, and Tell destination |
| | | Node |
| P | 4 Bit | Priority Plus QoS |
| DA | 32 Bit | Destination Address |
| SA | 32 Bit | Source Address |
| NH | 8 Bit | Next Header |
| R | 2 Bit | Read used for determine data Drop |
| | | location of concatenated Frames |
| Z | 8 Bit | Reserved for future use |
| SN | 6 Bit | Sequence Number ensure proper reassembly |
| | | of packet that fragmented across the |
| | | frame. |
| PTR | 16 Bit | Offset pointer - index of the start of |
| | | Data packet for destination node |
| | | Specified by the DA |
| FL | 8 Bit | Fragment Length |
| HEC | 8 Bit | Header Error Control (CRC) |

Referring back to FIG. 5a, when filling the payload 501 of the frame 407, 408 with IP packets, it is unlikely that an integral number of packets will exactly fit the payload 501. When an integral number of IP packets do not exactly fit the payload 501, there are two options. The first option is that, if a packet would exceed the capacity of the payload of the current frame, that IP packet is not placed into the payload of the current frame, and the remainder of the payload of the current frame is filled with stuff bytes. This excluded packet is then used to start filling the next frame. The second option is to fragment the packet, using part of its contents to fill the current frame and putting the remaining packet contents into a subsequent frame. To transport large IP packets, such as, for example, a 1500 octet packet, larger than an STS-1 SPE, the second option must be supported.

Both of these frame-filling options are available in the illustrated embodiment. If the payload 501 of the current frame 408 has only Q octets of capacity remaining, where Q is a software-configurable parameter, and the next packet selected for transport in this frame is larger than Q octets, then the next packet will be used to begin filling a subsequent frame and the remainder of the payload of the current frame will be filled with stuff bytes.

FIGS. 5a and 5b show a situation that a packet is fragmented so that part of the packet is transported in a subsequent frame. FIG. 5a shows that one packet fragment 504 is placed at the last of the payload 501, and FIG. 5b shows that the other packet fragment 512 is placed at the start of the payload 520 of the subsequent frame 407, 408. FIG. 5b also shows that packets 514, 516 and headers 508-510 fill the payload 520.

The fragment length field FL in the FEP header 508 of this subsequent frame is set to the number of octets from the packet that are transported in the packet fragment 512 within the payload 520 of the subsequent frame. FL is used by the receiving node to simplify packet extraction from the frame 408.

For unicast packets, all of the packets within a particular frame 407, 408 containing FEP headers and packets, often have the same node as their next destination along their path to their final destination. FEP also supports broadcast and multicast over the SONET network. Because FEP uses a MAC address on the frame-based network, broadcast and multicast can be handled in a manner similar to that used by Ethernet IP networks. For broadcast, the destination address DA is set to all ones and the DS bit is set to zero. This causes the frame 407, 408 to circulate on the network and then be stripped by the source node.

Multicast packets can be handled using various different methods. The first method is to use a broadcast frame. In this case, the other nodes on the ring receive the frame 408 and forward the packets both to the next node and to the node's router 409-412. The router then either utilizes or drops the packets, depending on whether any network connected to the node requires the multicast data. The second method is for the source node to replicate the packets and forward separate copies of the packets to each node that has subscribed to the multicast. The third method is to reserve a subset of the destination address space for multicast, as is done with Internet Protocol. A node can subscribe to a particular multicast by receiving frames having that specific multicast address. To accomplish this, the node is capable of receiving frames with various selected destination addresses.

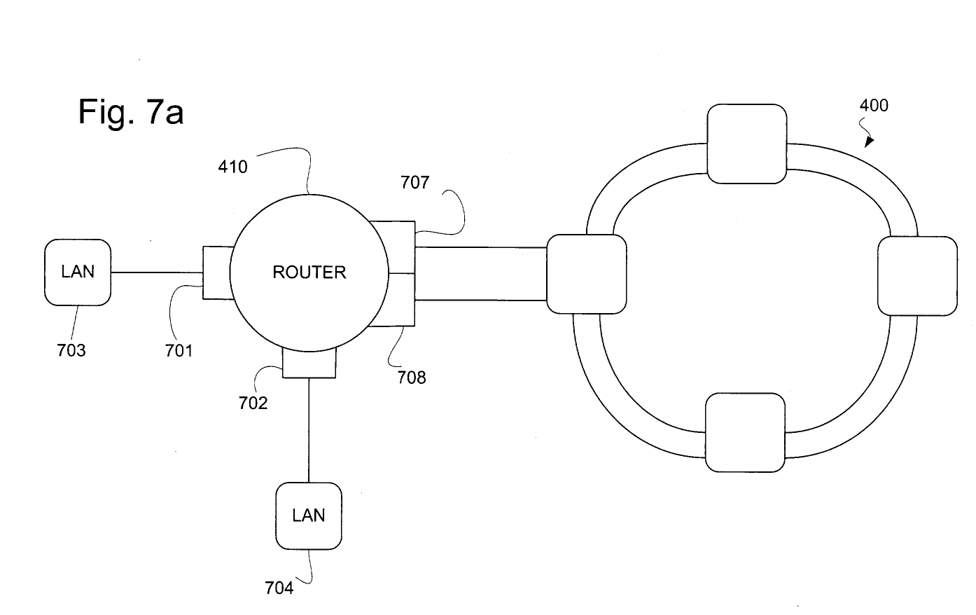

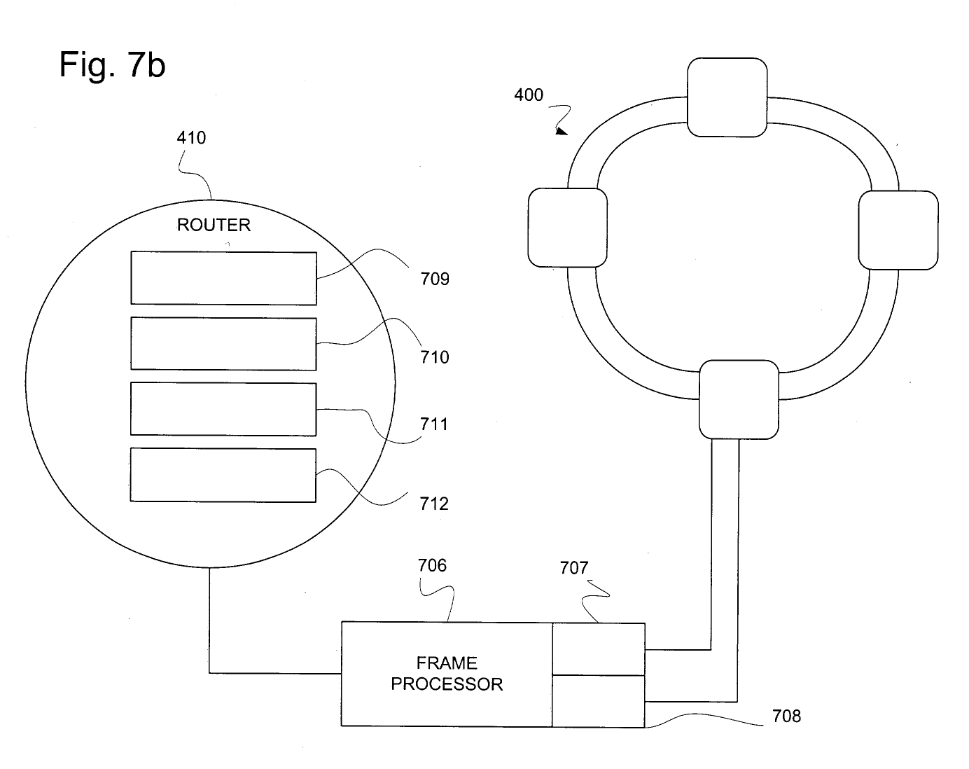

The present invention uses header concatenation, in which multiple FEP headers refer to the same packets. The multiple references to the same packets are achieved by using the same value for the PTR field in the multiple headers. FIG. 5c illustrates this header concatenation. In FIG. 5c, the payload contains three FEP headers 522, 524, 526 and one packet 528 that is associated with all of the three headers 522, 524, 526. This has two advantages. First, the frames 407, 408 are addressed only to the nodes that require them. They are not broadcasted. Therefore, unlike the processing of broadcast frames, only the multicast packets required by each router are forwarded to that router by a frame processor 706, which is explained later referring to FIG. 7b. Second, network bandwidth is not wasted by sending multiple copies of the same packets. This is in contrast to the replicate and forward method.

The present invention also provides schemes in which the FEP header or the FEP packet has a fixed, predetermined size. The schemes are explained referring to FIGS. 5d-5f. FIG. 5d shows a scheme in that fixed size headers and fixed size fills the payload. The header may have the same size as the packet. The packets are grouped after the headers that they belong to.

For the basic SONET frame STS-1 payload capacity, the predetermined size is 43 bytes. Since the payload capacity is about 774 bytes and the FEP packet is 43 bytes, 18 packets and headers fill completely up to 100% the payload of the concatenated SONET frame with end-users data.

FIG. 5e shows a scheme in that the headers are placed first in the payload and then the packets are placed. FIG. 5f shows a scheme in that the header and the packet are combined as a unit, and the unit has a predetermined size. Some of the fields of the header may be omitted to utilize the fixed size and arrangement of the headers and packets in each of the schemes. The small fixed size packets provide a granularity suitable for efficiently filling the payload size of a given frame. The fixed sizes will also simplify operations with FEP packets.

Referring now to FIG. 7a, the operation of each node will be described. When a local interface 701 such as an Ethernet interface receives packets from a local network 703, these packets are processed by the router connected to the local network 703, for example the router 410 in FIG. 4. If the node has a plurality of local interfaces, the next hop or destination for these packets will either be through another local interface 702 to some other local network 704 or-through a node that is reachable through an interface 707 or 708 on the frame-based network 400.

If the destination is reachable through a local interface 702, the router will send the packet to that local interface. If the destination is reachable through an interface 707, 708 on the frame-based network 400, the packet is queued into a frame buffer 709-712 by the router 410 as shown in FIG. 7b.

The router 410 maintains a plurality of frame buffers 709-712, normally at least one for every other node that is attached to the same frame-based network, that is, at least one buffer 709-712 for every node connected to the same SONET UPSR or BLSR. When multiple priority levels (refer to the above discussion of the P field) are used, there will normally be buffers for each supported individual priority level or group of priority levels. Each frame buffer 709-712 has a destination address DA that corresponds to the destination node. As packets arrive from the local interfaces 701,702, these packets fill the frame buffers 709-712.

The contents of a buffer 709-712 are ready to be moved from the router 410 and queued for transport with the frame processor 706 coupled to the interfaces 707, 708 on the frame-based network 400 when either of following two conditions is satisfied.

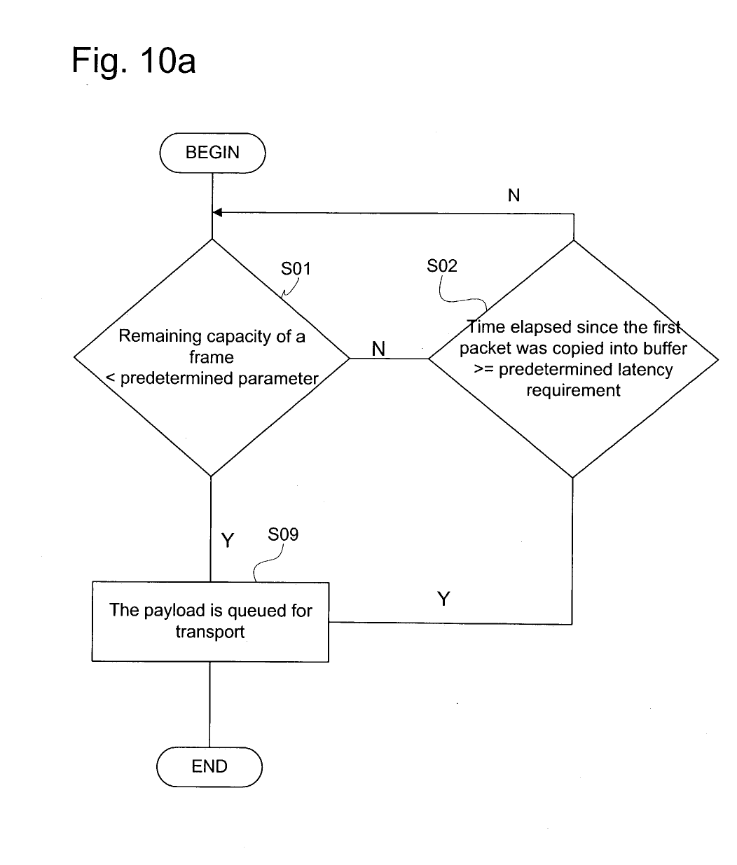

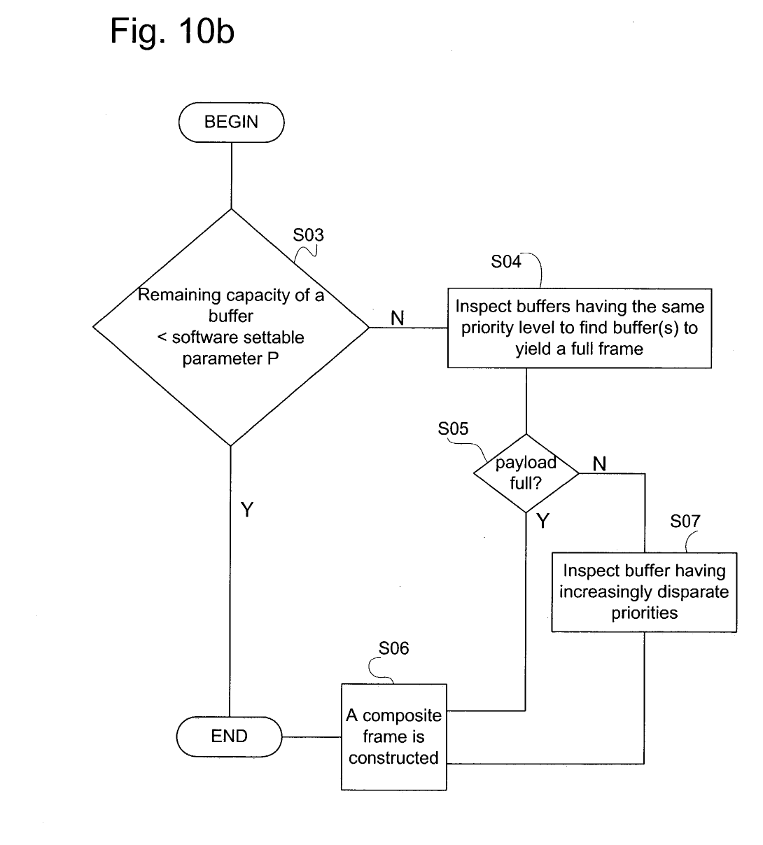

Referring to FIGS. 10a and 10b, in step S01, the first condition is that the frame 408 is sufficiently full, that is, it has less than Q octets of remaining capacity in its payload. In step S02, the second condition is that the time elapsed since the first packet (or fragment) was copied into the buffer meets or exceeds a prescribed latency requirement. When either condition is met, the process proceeds to step S09, in which the payload is queued for transport.

A composite frame 408 that contains packets, which are destined for more than one node on the ring, may be constructed when a buffer does not have enough packets to fill the payload. Packets from other buffers are selected according to their priorities. FIG. 10b illustrates this process. When the latency requirement is met in step S02, then in step S03, the remaining octet capacity of the buffer is obtained and compared to a software-settable parameter P. If the remaining capacity is less than P, the buffer is queued at S09 for transport. Otherwise, the remaining capacity of the other frame buffers is inspected to find (an)other buffer(s) that, when combined with the current buffer will yield a full, or nearly full, frame 408. In step S04, search for other buffers is conducted by inspecting buffers having the same priority level (or group) as the current buffer. In step S05, whether a suitable match(es) is found is checked. If the answer is yes in step S06, the process proceeds to step S05, in which a composite frame 408 is constructed, which contains the contents of the identified buffers. If the answer is no in step S05, search is performed for buffers with increasingly disparate priorities in step S07. In this way, the packets are filled in the payload of the frame 408 according to the value of the delivery requirement field of the header associated with the packets. Specifically, the payload of a frame is filled with packets having the same packet transport level first. Then if the capacity remaining in the payload is less than a predetermined packing limit and there is no packet having the same packet transport level, packets having increasingly disparate packet transport level are filled.

The composite frame 408 contains packets that are destined for more than one node on the ring. Therefore, the FEP header must indicate these multiple destinations. The simplest approach is to use a network multicast or broadcast address in the FEP header. The frame 408 would then be read by each node and forwarded to the node's internal router for further processing. The router would parse the frame 408, process any packets that are destined for the attached internal networks and discard the other packets. However, this approach increases the processing overhead, since each router would need to process the entire frame 408. Alternatively, the frame 408 could be parsed by a Field Programmable Gate Array (hereinafter FPGA) or other appropriate device to extract packets before sending frame 408 to the router 410. However, this approach is also inefficient because it requires the processing of the entire frame 408.

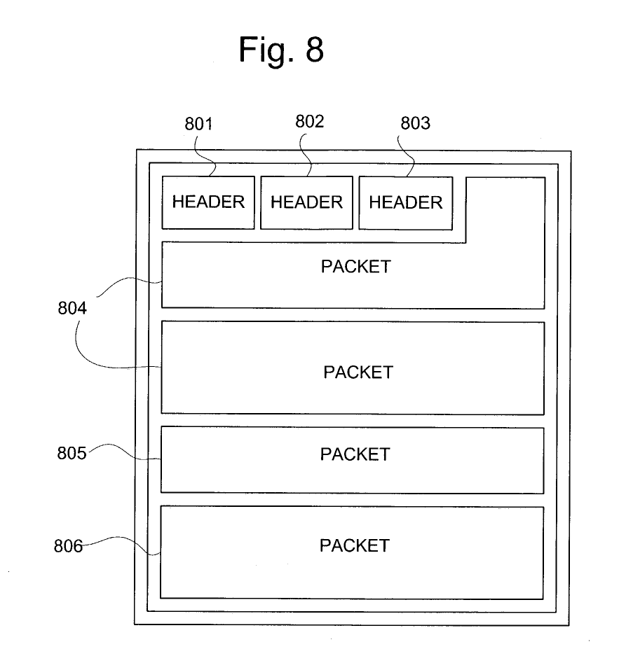

Header concatenation is used to eliminate this overhead with minimum data handling. Header concatenation for constructing the composite frames 408 is explained referring to FIG. 8. Considering, for example, the case of three destination nodes, a frame 408 that contains packets for multiple destinations is constructed having an FEP header for each node that is a destination for one or more packets within the frame 408. In step S06, after suitable buffers are found, an FEP header 801-803 is constructed for each of the destination nodes, and these headers 801-803 are placed at the start of the payload of the frame 408. The headers are followed by packets 804-806 being transported. The packets 804-806 are normally grouped in the same order as the headers, that is, the packets 804 for the destination node specified by header 801 immediately follow the last header 803. Two packets 804 are shown to illustrate that more than one packets having been destined to the same node can be associated with a single header. The packets 804 are followed by the packet 805 that are being sent to the node specified by header 802, and so on.

Alternatively, when the order of the groups of packets 804-806 is not in the same order as the FEP headers 801-803, the PTR field of the FEP header 801-803 are used to locate the packets 804-806.

As explained with reference to FIG. 10b, when selecting buffers for the composite frame 408, the first candidate buffers selected will have the same transport priority P. If insufficient buffers are found at the same priority, the search for candidate buffers is expanded to include buffers having similar priorities. Therefore, a composite frame 408 may contain packets having different priorities.

Nodes that forward the frame 408 do so based on the highest priority found among all of the FEP headers 801-803 for that frame 408. The search for this highest priority becomes trivial if the FEP header 801-803 having the highest priority is the first FEP header 801 in the frame 408. Alternatively, each node could treat forwarded traffic with a higher priority than traffic originating from that node.

When a composite frame 408 is received by a node 401-404, the frame processor connected to the node decrements the HL field and sets the corresponding R bit to one. If there is only one FEP header 801, or if all of the R bits in the FEP headers 801-803 are ones, the frame 408 has been received by all of the destination nodes and is dropped by the last destination node. A frame 408 is also dropped whenever the HL field becomes zero.

If the frame 408 is dropped, the node may send a frame 408 from its frame buffers 709-712 to an external interface 707, 708. If a node drops a frame 408 but does not have any frames 408 ready to send, it sends an advertising frame 408 so that the frame's capacity can be utilized by a node further along the ring. A frame 408 is marked as advertising by setting the DA and SA to zero.

When a frame 408 is received by the external interface 707, 708, the frame processor 706 inspects the first FEP header 801. If the destination address DA in this header 801 matches the address of this interface 707, 708, the frame processor 706 checks the NH field. If the NH field does not indicate a concatenated header, indicating that it is not a composite frame, the offset pointer PTR can be used to locate the start of the data packets and these packets are sent to the router 410.

If the frame 408 includes multiple FEP headers 801-803, the frame processor 706 checks each FEP header 801-803 for a matching destination address. When a matching address is found, the frame processor 706 uses the offset pointer PTR to locate the starting location of packets that are destined for this node. If the matching FEP header is not the last FEP header 803, then the frame processor 706 uses the offset pointer PTR of the next FEP header to locate the end of the packets that are destined for this node. These offset pointers PTR permit the frame processor 706 to extract the group of packets for this node without inspecting other groups of packets. This pre-processing of the frames 408 by the frame processor 706 reduces the amount of data forwarded to the router 410, thereby reducing both the processing load on the router 410 and the required bandwidth for data transfers from the external interfaces 707, 708 to the router 410. Once the packets have been extracted by the frame processor 706, the packets are sent to the router 410.

If none of the destination addresses DA in the FEP headers 801-803 match the address of this interface 707, 708, the HL field is decremented and, if HL has not reached zero, the frame 408 is queued to an interface on the frame-based network to be transported to the next node.

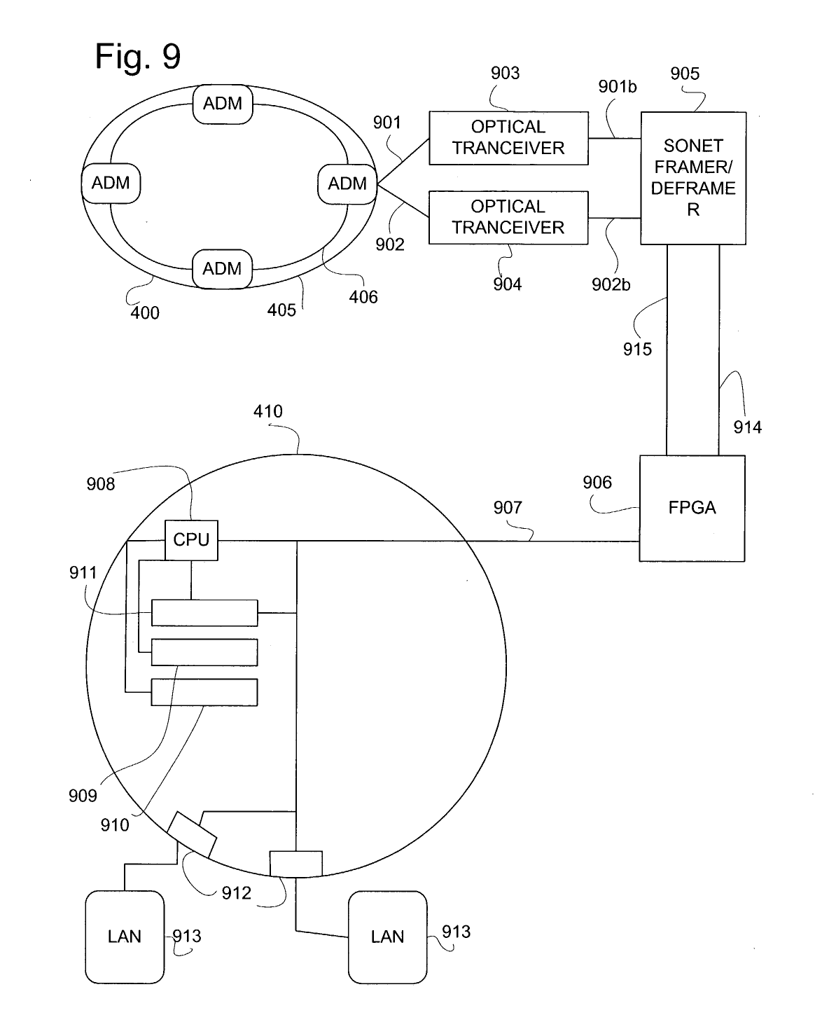

FIG. 9 schematically shows an apparatus of the invention designed for use in a SONET OC-3 BLSR. There are two bi-directional connections 901, 902 to the SONET ring 400. One connection 901 is to the inner ring 406 and the other connection 902 is to the outer ring 405. The BLSR supports concurrent traffic in both rings. Two optical transceivers 903, 904, convert incoming photonic signals from the SONET ring 400 into electrical signals which serve as inputs to a SONET framer/deframer 905. The transceivers 903, 904 also convert outgoing electrical signals from the framer/deframer 905 into photonic signals 901b, 902b.

When a SONET frame is received, the framer/deframer 905 aligns the data stream and determines the SONET frame boundaries. The framer/deframer 905 extracts the section, line, and path overhead bytes which are transferred over conductors 914 and used as inputs to an FPGA 906. The SPE is also extracted from the SONET frame and is transferred over a bus 915 to the FPGA 906. The FPGA 906 implements the frame processor and handles the queuing of output frames 408. It also implements utility functions such as the CRC computation and the payload scrambler/descrambler. The payload scrambler polynomial in the current embodiment is the standard X⁴³+1. The FPGA 906 contains an interface to a 32-bit Peripheral Component Interconnect (PCI) bus 907, which serves as the system bus. The router 410 is also connected to the PCI bus 907. The router 410 is implemented using a high-integration CPU 908. One or more Ethernet devices 912 are also coupled to the PCI bus 907. Each Ethernet device 912 provides an interface to an external network 913, 914. The external network 913, 914 can serve as a source or a destination for the packet data.

When the FPGA 906 receives frames 408 containing packets that are destined for the node, that is, those having a matching DA, multicast address, or broadcast address, it extracts the packets and transfers them to the router 410. The transfer mechanism is direct memory access over the PCI bus 907 to the router memory 911. An interrupt is then sent to the router 410. The router 410 processes the packets using known IP routing algorithms.

If the frame 408 is not stripped by the node, then the FPGA 906 buffers the frame 408 and queues it for transport on another interface on the ring. If the frame 408 is stripped by the node or marked as advertising, then the FPGA 906 may send a frame 408 that has previously been queued for transport. The source of this queued frame 408 is normally the router 410. If there are no frames 408 to send, the frame 408 is marked as advertising by setting the DA and the SA to zero so that the frame 408 can be used by another node.

The router 410 requires the CPU 908 plus additional components including a non-volatile program and data store 909, a boot ROM 910, and a RAM 911.

When the invention is used for the transport of IP traffic, the inner and outer rings 406, 405 can be treated as network interconnections on different subnetworks by the routing software. However, since the illustrated embodiment contemplates the use of SONET protection switching, which affects the network topology, signals from the SONET APS (which are generated by the framer/deframer 905) are processed by the FPGA 906 and sent to the router 410 so that it can update its routing tables accordingly.

Additionally, when using typical routing software, for example, software developed for Ethernet networks, all nodes on the same BLSR appear to be on the same two subnetworks. Therefore, other nodes on a subnetwork could appear to be only one hop away even though the frames 408 may pass through several other nodes. To improve performance, the router 410 can be made aware of the actual hop count and ring topology when sending frames 408 to other nodes. This is facilitated by having the nodes send out topology discovery packets on a regular basis. As each topology packet passes through a node, the node appends its MAC address, ring ID, and status. When the topology packet returns to the originating node, the originating node uses this information to construct accurate routing metrics. This is a novel use of topology packets to provide and update the hop count for the interfaces on a frame-based network.

The invention combines the functionality of a router and an ADM, but it could be implemented using a separate router.

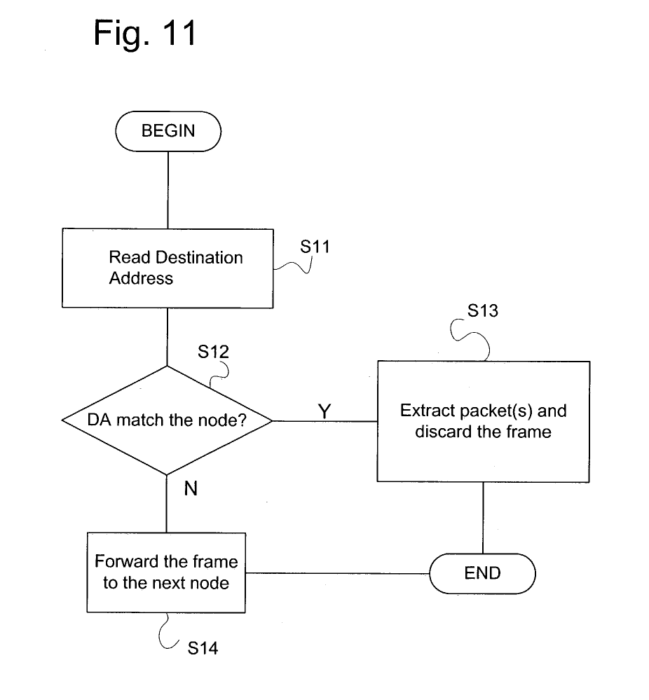

The methods of the present invention are further explained below referring to flow diagrams, FIGS. 11-18.

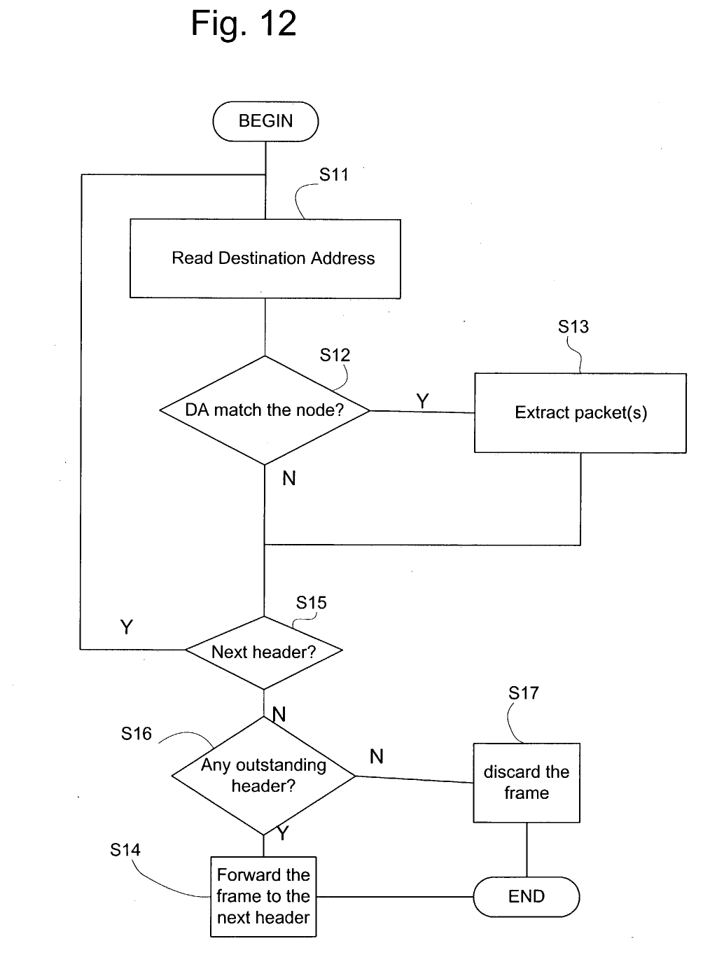

FIGS. 11 and 12 show a method for transporting packets through the electronic internetwork 400. The electronic network 400 includes a plurality of nodes 401-404. Each of the nodes is connected to a local network. The transportation unit of the electronic internetwork 400 is a frame. A frame is transported from a source node to one or more destination nodes. A frame comprises a payload, and a source address is an address corresponding to the address of the source node of a packet, and a destination address is an address corresponding to the address of the destination node of a packet. A current node is a node performing the method in the electronic internetwork 400. The method comprises the step of transporting a frame through the electronic internetwork. The payload of the frame includes one or more headers and one or more packets associated with each header, and each of the headers includes a destination address field that indicates the destination address of the associated packets.

The transporting step includes header reading step and frame processing step. FIG. 11 shows the case that there is only one FEP header in the frame. The header reading step includes destination address reading step S11, in which the value of the DA field of a header is read. The frame processing step includes three steps S12-S14. In step S12, the value of DA read in step S11 is checked if it matches the address of the current node. If the answer is yes, the packets associated with the header are extracted in step S13. If the answer is no, the frame is forwarded to the next node in step S14.

FIG. 12 shows the case that there may be more than one headers in the frame. In step S15, whether a next header follows is checked. If the answer is yes, the steps S11, S12, S13 are repeated for the next header. In this way, the header reading step and the frame processing step are repeated for each header. If the answer in step S15 is no, that is, if all of the headers are read, the process goes to step S16, in which whether there is any outstanding header is checked. If the answer is no, that is, there is no header(s) that should be processed by another node(s), the frame is discarded in step S17. Otherwise the process goes to the step S14 in which the frame is forwarded to the next node.

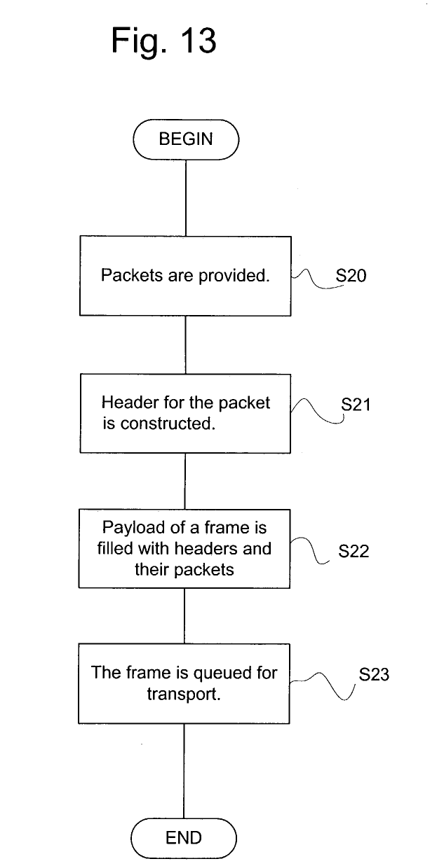

FIG. 13 shows a process for constructing a frame with packets from a local network. When there are packets from the local network connected to the current node, the current node constructs headers for packets from the local network connected to the current node and fills the payload of a frame with the headers and packets. In step S20, packets are provided from the local network. In step S21, headers for the packets are constructed. In step S22, a payload of a frame is filled with the headers and the packets associated with the headers. In step S23, the constructed frame is queued for transport.

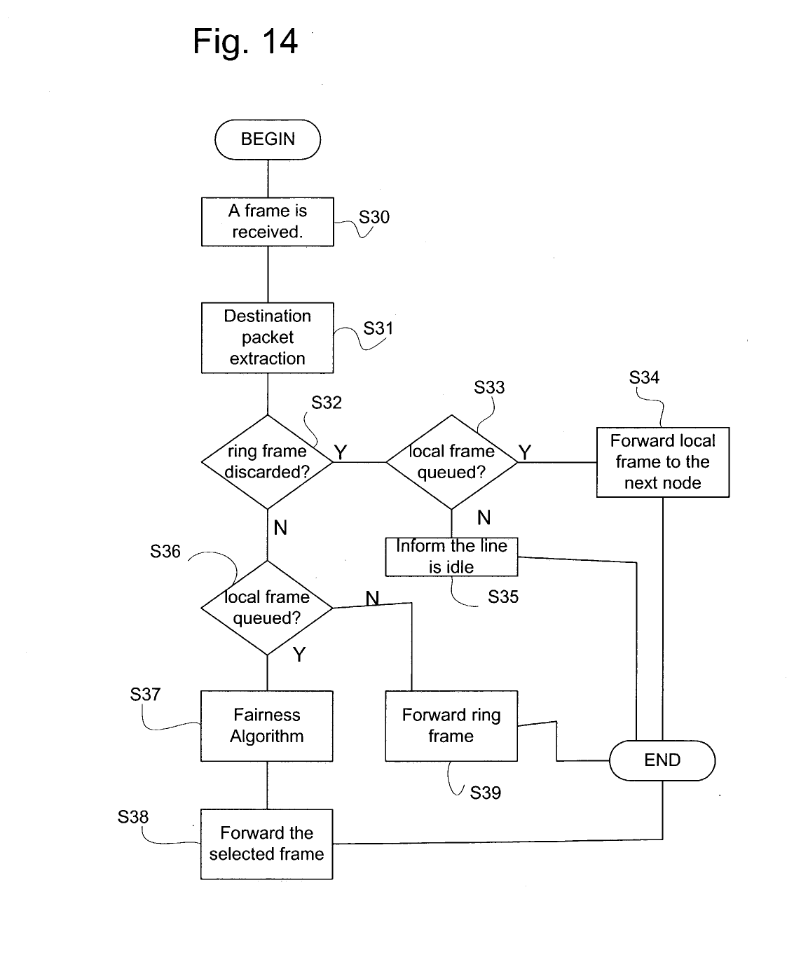

FIG. 14 shows a process for sending frames at the current node. Frames may be received by the node (ring frames hereinafter), or frames may be constructed at the node (local frames hereinafter) as explained above referring to FIG. 13. In step S30, a ring frame is received by the current node. In step S31, packets destined for the current node are extracted according to the process explained referring to FIG. 12. In step S32, whether the ring frame is discarded is checked. If the answer in step S32 is yes, whether there is a local frame queued is checked in step S33. If the answer in step S33 is yes, the local frame is forwarded to the next node in step S34. If the answer in step S33 is no, that is, there is no frame to forward, the current node informs the network that there is no frame to send and the line is idle, in step S35. If the answer is no in step S32, whether there is a local frame queued is checked in step S36. If the answer in step S36 is yes, a fairness algorithm is performed in step S37 to select a frame to send, and the selected frame is forwarded to the next node in step S38. If the answer in step S36 is no, the ring frame is forwarded to the next node in step S39.

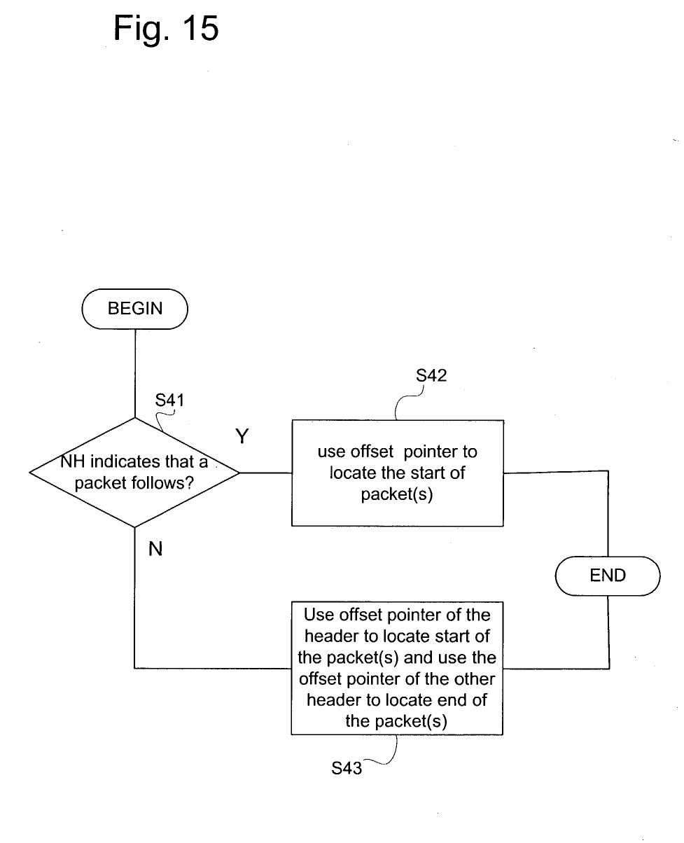

FIG. 15 shows a process for identifying the start and end positions of the packets to be extracted. The frame processing step further includes following steps. When the value read in the destination address reading step matches the address of the current node, whether the next header field indicates that a packet follows the header is checked in step S41. If the answer in step S41 is yes, the offset pointer field is used to locate the starting position of the packets associated with the header in step S42. If the answer in step S41 is no, that is, if the next header field indicates that another header follows the header, the offset pointer field is used to locate the starting position of the packets associated with the header, and the offset pointer field of the another header is used to locate the end position of the packets associated with the header in step S43.

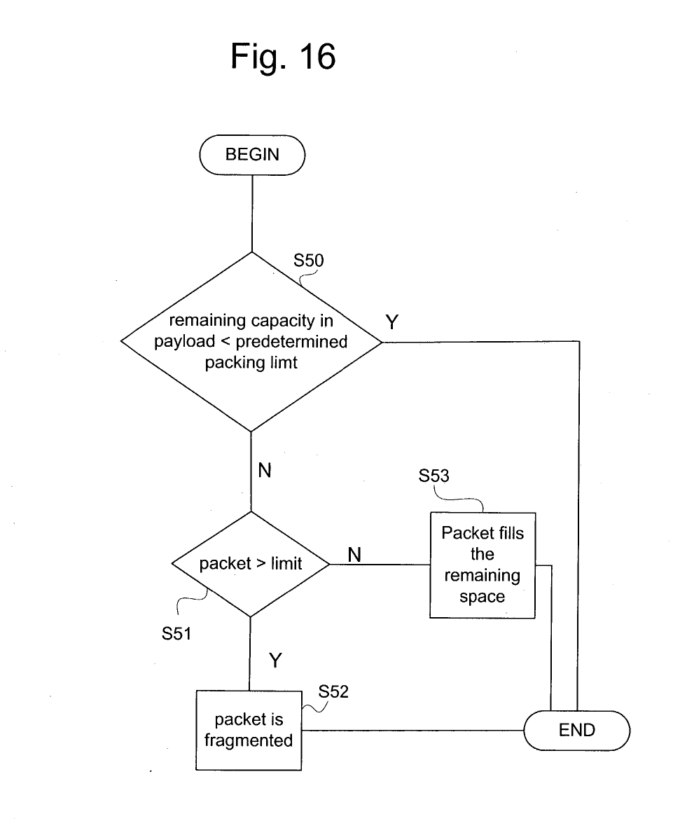

FIG. 16 shows a process for fragmenting a large packet. In step S50, whether the capacity remaining in the payload of a frame is less than a predetermined packing limit is checked. If the answer in step S50 is yes, no packet is placed in the remaining capacity. If the answer in step S50 is no, whether a packet that is sought to fill the payload is larger than the remaining capacity is checked in step S51. If the answer in step S51 is yes, the packet is fragmented in step S52. Also in step S51, the fragment length field of the header of the next frame associated with the fragmented packet is set to the number of octets of the fragmented packet. If the answer in step S51 is no, the packet is used to fill the remaining space of the frame in step S53.

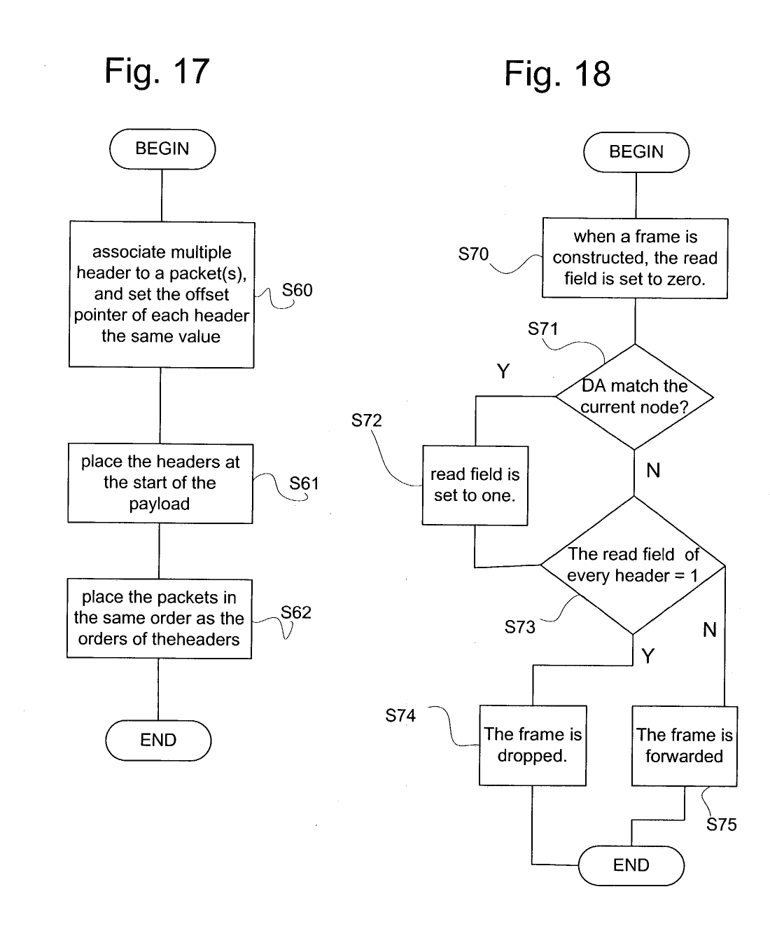

FIG. 17 shows a process for header concatenation. In step S60, more than one headers are associated with one packet, and the offset point field of the headers are set to have the same value. Each of the headers has a different value for the destination address field. In step S61, the headers are placed at the start of the payload of a frame. In step S62, the packets are placed after the headers. The packets are grouped in the same order as the headers.

FIG. 18 shows a process for using a flag for checking that packets associated for a particular head are already read. In step S70, the read field is initially set to zero when a frame is constructed. In step S71, whether the destination address read in the destination address reading step matches the address of the current node is checked. If the answer in step S71 is yes, the read field is set to one in step S72 and then the process goes to step S73. If the answer in step S71 is no, the process goes to the step S73 directly. In step S73, whether the read field of every header in a frame indicates that the header is read is checked. If the answer in step S73 is yes, the frame is dropped in step S74. Otherwise, the frame is forwarded to the next node in step S75.

The invention has been presented in the context of a SONET BLSR. However, it is applicable to any network having a physical or virtual ring topology. It can also be used for linear or mesh topologies. When the path through the network's topology does not have a closed loop, frames that in a closed loop would be dropped by the originating node are dropped by the node at the termination of the path. It can also be used in systems where the network capacity is allocated or channelized using any of, or any combination of, time-division multiplexing, frequency-division multiplexing, wavelength-division multiplexing, code-division multiplexing, or space-division multiplexing. The invention is independent of the network protocol of the packets being transported and that the only requirement for applicability is the need to transport a plurality of packets within a sequence of one or more frames. It is also independent of the technology of the physical layer of the network.

With regard to the priority field P, QoS implemented by the present invention is explained below. In simple terms, QoS mechanisms provide the ability to distinguish one type of traffic from another so that the network can provide each type of traffic that the particular handling or forwarding treatment needs. The fixed size IP-Packet QoS capabilities of the present invention can prioritize this kind of traffic over all other traffic. Predictable service can be assured by scalable bandwidth, and low latency. Regardless of who owns and operates the network, QoS ensures that the performance of mission-critical and delay-sensitive applications isn't compromised by other applications.

When the high priority data encapsulated over SONET frame in Line Overhead, and corresponding to Path-Overhead, it will raise flag called (Triples) that will inform the entire network, that this package has the expressway of the bandwidth, deliver the data to its destination directly. Clearly, end-to-end QoS can only be delivered through the coordinated action of multiple intermediaries.

The present invention provides beside the class of services, high capacity utilization, priority scheduling, proprietary low-latency packet transport, bandwidth scalability, and finally low transport overhead, that is include integral Router.

FEP accommodates packet marking, the DiffServ defined the Differentiated Services (DS) field. This field consists of the six most significant bits in the original IPv4 Type of Service (TOS) octet and the IPv6 Traffic Class octet. The values in the DS field, known as DiffServ Code Points (DSCPs), determine how packets are treated as they're forwarded across a network.

Alternately, the present invention does not need signaling or admission control, because the present invention transports directly over SONET network that it give us more advantages, such that if no routers in the DiffServ domain are RSVP-aware, the RSVP messages will be passed transparently.

Other advantages of using SONET fast, less noise, and more secure network from the hackers are provided. Due to new packet encapsulation over SONET give the network inherently the security, and protection from any intruders even to get in the networks ever.

The present invention provides QoS capabilities, including packet priority, and class-based queuing. The Network routers are capable of classifying traffic based on a variety of packet overhead information, including Layer 3 source and destination addresses. Type Of Service bits, priority data types. Because all classification is done in simple hardware yet high performance delivered guaranteed.

The present invention uses real-time transport protocol, and we embedds the QoS method within the SONET frame. This allows more customers data to be transported, low latency, with very secure networks, which is (SONET), and bandwidth scalability.

The present invention delivers pure bandwidth data in Ethernet format where can connect directly to client file server. Regarding distance limitation, the present invention supports 750 KM from the SONET side, and from Ethernet side it uses Ether-fiber for up-to 50 KM radius from the P-Box to the customers' premises.

Although the invention has been described in considerable detail, other versions are possible by converting the aforementioned construction. Therefore, the scope of the invention shall not be limited by the specification specified above.

What is claimed is:

1. A method for transporting packets through an electronic internetwork, wherein the electronic network includes a plurality of nodes, wherein the transportation unit of the electronic internetwork is a frame, wherein a frame is transported from a source node to one or more destination nodes, wherein a frame comprises a payload, wherein the payload of the frame includes one or more headers and one or more packets associated with each header, wherein a source address is an address corresponding to the address of the source node of a packet, and a destination address is an address corresponding to the address of the destination node of a packet, and wherein a current node is a node processing a particular frame in the electronic internetwork, comprising:
a) transporting a frame through the electronic internetwork;
wherein each of the headers includes a destination address field that indicates the destination address of the associated packets.

2. The method of claim 1, wherein each of the nodes is connected to a local network, wherein the method further comprises a step of forming a frame with a packet or packets from the local network at the source node.

3. The method of claim 2, wherein the transporting step includes header reading step and frame processing step,
wherein the header reading step includes destination address reading step, in which the value of the
destination address field of a header is read, wherein in the frame processing step, if the value read in the destination address reading step matches the address of the current node, the packets associated with the header are extracted, and
wherein the header reading step and the frame processing step are repeated for each header.

4. The method of claim 3, wherein in the frame forming step, when there are packets from the local network connected to the current node, the current node constructs headers for packets from the local network connected to the current node and fills the payload of a frame with the headers and packets.

5. The method of claim 4, wherein if the frame received from the previous node is discarded, the current node forwards the frame to the next node.

6. The method of claim 4, wherein if there is no frame to forward, the current node forwards an advertising frame to the next node.

7. The method of claim 6, wherein the header further includes a source address field that indicates the source address of the associated packets.

8. The method of claim 7, wherein the size of the destination address field is 32 bit, and the size of the source address field is 32 bit.

9. The method of claim 8, wherein a frame is marked advertising by setting the destination address field and the source address field of header to zero.

10. The method of claim 4, wherein when the remaining capacity of the payload of a frame has less than a predetermined remaining capacity parameter, the payload is queued for transport.

11. The method of claim 4, wherein packets from the local network are stored in a buffer, wherein the payload is queued for transport when the time elapsed since the first packet was copied into the buffer is equal or greater than a predetermined latency requirement.

12. The method of claim 4, wherein the header further includes a delivery requirement field that indicates a packet transport level of the associated packet.

13. The method of claim 12, wherein the delivery requirement field indicates priority of queuing of the packet.

14. The method of claim 12, wherein packets are filled in the payload of the frame according to the value of the delivery requirement field of the header associated with the packets.

15. The method of claim 14, wherein the payload of a frame is filled with packets having the same packet transport level.

16. The method of claim 15, wherein if the capacity remaining in the payload is less than a predetermined packing limit and there is no packet having the same packet transport level, packets having increasingly disparate packet transport level are filled.

17. The method of claim 3, wherein the header further includes a destination strip filed that instructs the destination node whether or not to forward the frame.

18. The method of claim 17, wherein when the packet is a broadcast packet, the destination address field is set to all ones, and the destination strip field indicates that the packet and the header should be forwarded to the next node.

19. The method of claim 3, wherein the header further includes a next header field, which indicates whether another head follows immediately the header or a packet follows immediately the header, and an offset pointer field, which indicates the start position of the packets associated with the header measured from the start of the payload of the frame.

20. The method of claim 19, wherein in the frame processing step, if the value read in the destination address reading step matches the address of the current node, the next header field is checked,
wherein if the next header field indicates that a packet follows the header, the offset pointer field is used to locate the starting position of the packets associated with the header,
wherein if the next header field indicates that another header follows the header, the offset pointer field is used to locate the starting position of the packets associated with the header, and the offset pointer field of the another header is used to locate the end position of the packets associated with the header.

21. The method of claim 19, wherein more than one header are associated with one packet, and the offset point field of the headers have the same value.

22. The method of claim 21, wherein each of the headers has a different value for the destination address field.

23. The method of claim 22, wherein the headers are placed at the start of the payload of a frame, and the packets are placed after the headers.

24. The method of claim 23, wherein the packets are grouped in the same order as the headers.

25. The method of claim 3, wherein if the capacity remaining in the payload is less than a predetermined packing limit and a packet that is sought to fill the payload is larger than the predetermined packing limit, the packet is used to begin filling the payload of a subsequent frame,
wherein if the capacity remaining in the payload is greater than the predetermined packing limit and a packet that is sought to fill the payload is larger than the remaining capacity, the packet is fragmented.

26. The method of claim 25, wherein the header further includes a fragment length field that indicates the length of the first packet associated to the header if the first packet is a fragmented packet.

27. The method of claim 26, wherein when the packet is fragmented, the fragment length field of the header of the next frame associated with the fragmented packet is set to the number of octets of the fragmented packet.

28. The method of claim 3, wherein the header further includes a hop limit field that indicates hop limit.

29. The method of claim 28, wherein the initial value of the hop limit field is controlled by a hop limit parameter that is adjustable by software at the node that the header is created.

30. The method of claim 29, wherein each node that forwards a frame decrements the hop limit field by one.

31. The method of claim 30, wherein the frame is discarded if the value of the hop limit is zero.

32. The method of claim 3, wherein the header further includes a read filed that indicates whether the destination node has read the header.

33. The method of claim 32, wherein the read field is initially set to zero, and wherein the read field is set to one if the destination address read in the destination address reading step matches the address of the current node.

34. The method of claim 33, wherein if the read field of every header in a frame indicates that the header is read, the frame is dropped.

35. The method of claim 3, wherein the electronic internetwork has a ring topology, and the header further includes a ring indicator field that indicates the ring on which the frame was originally sent.

36. The method of claim 3, wherein the header further includes a sequence number field that indicates a sequence number of the header.

37. The method of claim 36, wherein the sequence number field is a modulo-64 counter.

38. The method of claim 3, wherein the header further includes a header error control field that is used for cyclic redundancy check.

39. The method of claim 3, wherein the packets are IP packets, and the frame is a SONET frame.

40. The method of claim 3, wherein the header is used as a MAC layer header.

41. The method of claim 3, wherein the frame includes two or more subframes, wherein each of the subframes includes one or more headers and one or more packets associated with each header.

42. The method of claim 3, wherein each of the packets has a predetermined size.

43. The method of claim 42, wherein the predetermined size is 43 bytes.

44. The method of claim 42, wherein each of the headers has the predetermined size.

45. The method of claim 3, wherein each of the headers and each of the packets are combined as a unit, and the unit has a predetermined size.

46. A system for transporting packets through an electronic internetwork, wherein the electronic network includes a plurality of nodes, wherein the transportation unit of the electronic internetwork is a frame, wherein a frame is transported from a source node to one or more destination nodes,
wherein a frame comprises a payload, wherein the payload of the frame includes one or more headers
and one or more packets associated with each header, wherein a source address is an address corresponding to the address of the source node of a packet, and a destination address is an address corresponding to the address of the destination node of a packet,
wherein a current node is a node processing a particular frame in the electronic internetwork, and
wherein each of the headers includes a destination address field that indicates the destination address of the associated packets.

47. The system of claim 46, wherein each of the nodes is connected to a local network, wherein a frame is formed with a packet or packets from the local network at the source node.

48. The system claim 47, wherein the current node reads the value of the destination address field of each of the headers, and wherein if the value read matches the address of the current node, the current node extracts the packets associated with each of the headers.
